(19) United States
(12) Patent Application Publication
(10) Pub. No.: US 2024/0005777 A1
(43) Pub. Date: Jan. 4, 2024

(54) Management Agent for Real-Time Interpretable Telemetry

(71) Applicants: Kshitij Doshi, Tempe, AZ (US); Mahesh Ketkar, Santa Clara, CA (US); Rahul Khanna, Portland, OR (US); Muhammad Khellah, Tigard, OR (US); Ryan Kim, Beaverton, OR (US); Mohan Kumar, Aloha, OR (US); Minh Le, North Plains, OR (US); Sten Sogaard, Santa Clara, CA (US); James Tschanz, Portland, OR (US); Sriram Vangal, Portland, OR (US)

(72) Inventors: Kshitij Doshi, Tempe, AZ (US); Mahesh Ketkar, Santa Clara, CA (US); Rahul Khanna, Portland, OR (US); Muhammad Khellah, Tigard, OR (US); Ryan Kim, Beaverton, OR (US); Mohan Kumar, Aloha, OR (US); Minh Le, North Plains, OR (US); Sten Sogaard, Santa Clara, CA (US); James Tschanz, Portland, OR (US); Sriram Vangal, Portland, OR (US)

(21) Appl. No.: 18/368,480

(22) Filed: Sep. 14, 2023

(51) Int. Cl. G08C 15/06

(52) U.S. Cl. CPC G08C 15/06

(57) ABSTRACT

A controller of a processor core may select telemetry data generated by a plurality of sensors of the processor core at a first time interval of a plurality of time intervals. The controller may transform the telemetry data based at least in part on a model. The controller may detect a change at the first time interval based on the transformed telemetry data. The controller may determine an event based on the change. The controller may initiate an action during the first time interval based on the event.

### BACKGROUND

Computing hardware such as processors may produce telemetry data that can be used to monitor events and complex interactions. Conventional analysis software may execute as system software (e.g., as an application in an operating system (OS)), which introduces significant latency, as significant amounts of telemetry data needs to be transferred for the analysis. Such implementations may not be standardized for general-purpose, exploratory, or customer-specific use cases.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates an aspect of the subject matter in accordance with one embodiment.

FIG. 7 illustrates an aspect of the subject matter in accordance with one embodiment.

FIG. 8 illustrates an aspect of the subject matter in accordance with one embodiment.

FIG. 9 illustrates an aspect of the subject matter in accordance with one embodiment.

FIG. 10 illustrates an aspect of the subject matter in accordance with one embodiment.

FIG. 11 illustrates an aspect of the subject matter in accordance with one embodiment.

FIG. 12 illustrates an aspect of the subject matter in accordance with one embodiment.

FIG. 13 illustrates an aspect of the subject matter in accordance with one embodiment.

FIG. 14 illustrates an aspect of the subject matter in accordance with one embodiment.

FIG. 15 illustrates an aspect of the subject matter in accordance with one embodiment.

FIG. 16 illustrates an aspect of the subject matter in accordance with one embodiment.

FIG. 17 illustrates a logic flow 1700 in accordance with one embodiment.

FIG. 18 illustrates an aspect of the subject matter in accordance with one embodiment.

### DETAILED DESCRIPTION

Embodiments disclosed herein provide techniques for actionable telemetry data in computing hardware. For example, computer processors may provide converged telemetry to enable features such as a telemetry semantic space (TSS), telemetry watchers, and telemetry aggregators. The telemetry data may be used in various contexts, such as resource optimization, error correction, and the like. However, conventional solutions may implement these features in system software executing on the processor, which suffers from large latency (e.g., when transferring the telemetry data from the source to memory space accessible by the system software executing on processor).

More specifically, embodiments disclosed herein provide artificial intelligence (AI) driven telemetry at the hardware level (e.g., the chiplet level, package level, die level, system-on-chip (SoC) level, etc.) to enable actionable insights empowered with the ability to score and/or infer microtransactions in real-time and without impacting service level agreements (SLAs) and/or service level objectives (SLOs) for guest services. More generally, embodiments disclosed herein provide an open framework of hardware assisted and AI-enabled extensions to converged telemetry that opens new opportunities for solving system optimization and/or system fault problems.

More specifically, embodiments disclosed herein provide a hierarchical network of telemetry data collectors and on-die processing. The on-die processing may be based on one or more selectable software configurations (e.g., configurations provided by the hardware manufacturer and/or user-defined configurations). The configurations (e.g., algorithms) may be used for various purposes, such as predicting workload needs, allocating system resources, monitoring system health, performing corrective actions, and/or any other purpose. The hierarchical network allows telemetry data and results of processing the telemetry data to be shared in the network. Furthermore, the hierarchical network is scalable to add additional collectors as processing architectures increase in complexity.

In some embodiments, the configurations may be included in a system management agent (SMA) which may be deployed as an execution container (EC) within a hardware engine (e.g., circuitry for a controller or microcontroller). The EC may exist at various levels, such as a local level (e.g., within or proximate to a processor core) and/or a global level (e.g., within an input/output (I/O) memory hub in a server SoC). The EC may act as a signed sandbox with an access control mechanism. The access control mechanisms may be defined based on a given configurations for the SMA and may define parameters such as the frequency of telemetry data collection, access restrictions to specific telemetry sources, resource control knobs, access to statistical hardware accelerators, and/or access to other hardware accelerators. Generally, the SMA may include logic for telemetry data ingestion, telemetry data modeling, change detection, statistical interpretation, and event triggers, each of which may be based on a given SMA configuration.

In some embodiments, an engine may improve the statistical interpretation and filtering of telemetry data simultaneously generated by the system. The engine may be implemented close to the source of the telemetry data (e.g., by the SMA) using running-window time-series histograms. The time-series histograms may be processed to identify the telemetry data of the most relevance during a time interval where the system is realizing uncharacteristic performance activity. The engine may be allocated to a predetermined group of telemetry elements (e.g., sensors and/or telemetry data), where the predetermined group is based on the configurations and/or user input. The allocation of the engine may induce parallelism for real-time analysis. The SMA may configure the time-series telemetry data ingestion based on the predetermined group of telemetry elements and cause the timely analysis of the time-series telemetry data using real-time histogram analysis supported by hardware accelerators. The histogram generation may permit analysis of attributes such as mean shift, variance, slope, skewness, and/or change-points per time interval in a streamlined manner. In some embodiments, a measure of relative entropy between histograms using hardware-accelerated divergence functions. One example of a divergence function is the Kullback-Leibler (KL) divergence. Doing so may allow the SMA to detect a change in the operation of the system, e.g., a rare event or anomaly. More generally, by enabling fine-grained histogram generation, the SMA may derive statistics from the telemetry data, including but not limited to statistics related to change detection, mean and/or variance analysis, marking the telemetry data with interpretable tokens for objective-driven analysis, forecasting trends for phase realignments, proactive resource allocation, fingerprinting, and/or stationary analysis.

Telemetry data may include information that characterizes the attributes of a given telemetry sensor. However, the telemetry data may include strong noise, random fluctuations, jitter, errors, interference, non-linear characteristics, non-stationary characteristics, and transient characteristics. In some embodiments, the telemetry data may be pre-processed, e.g., to remove noise, fluctuations, jitter, errors, interference, and other characteristics, prior to the statistical processing (e.g., to identify trends, patterns, seasonality, decisions, or regressions). The pre-processing may include any processing operation, such as filtering (e.g., high pass filters, low pass filters, etc.), statistical methods (e.g., Bayesian filtering, Kalman filtering, etc.), isolating decay factors, smoothing techniques (e.g., applying a moving average or other filter to reduce the effects of noise), and/or deep-learning based techniques (which may include training a neural network to learn the underlying structure of the telemetry data and remove the noise). Removing the noise and other undesirable attributes of the telemetry data may improve the usefulness and effectiveness of the telemetry data, e.g., as denoised telemetry data may lead to improved fault detection, anomaly detection, workload balancing, etc.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, a logic flow may be implemented by a hardware element, a software element executed by a processor, or any combination thereof. The embodiments are not limited in this context.

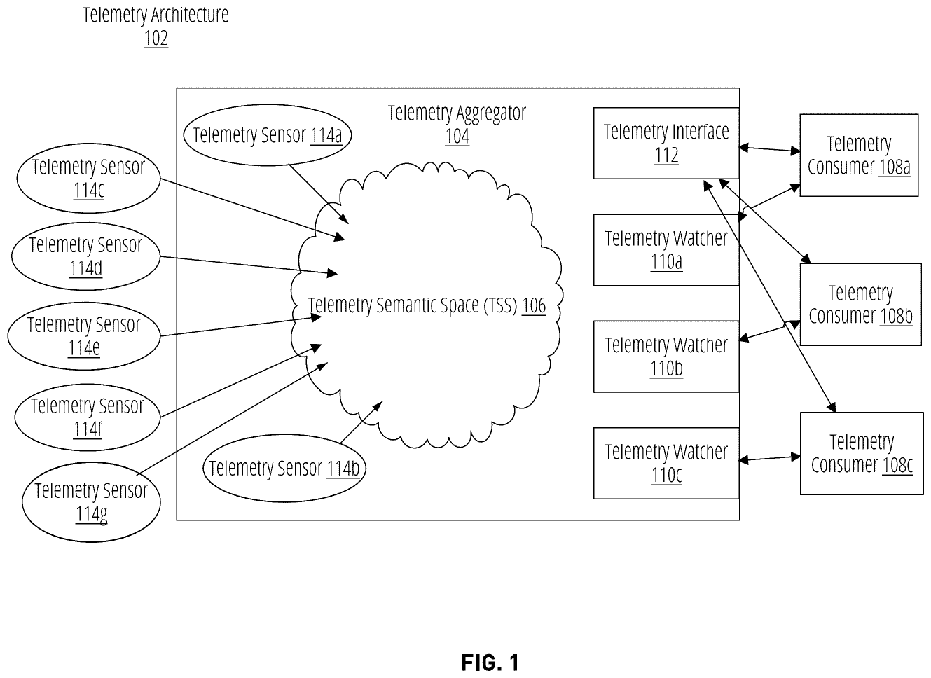

Turning now to FIG. 1, telemetry architecture 102 is depicted. Telemetry architecture 100 can be implemented on an integrated circuit, for example, in accordance with embodiments of the present disclosure. In some examples, telemetry architecture 100 may be implemented on an integrated circuit. The integrated circuit may be included in a processor, a system-on-chip (SoC), single die package, a multi-chip module (MCM), a multi-die package, a chiplet, a dielet, a bridge, an interposer, a discrete package, an add-in card, a chipset, or any other computing hardware.

As depicted, telemetry architecture 102 includes telemetry aggregator 104, telemetry semantic space (TSS) 106, telemetry consumer 108a, telemetry consumer 108b, telemetry consumer 108c, telemetry watcher 110a, telemetry watcher 110b, telemetry watcher 110c, telemetry interface 112, and telemetry sensors 114a-114g.

In general, TSS 106 describes a set of telemetry information, which can be generated and/or exposed by telemetry aggregator 104, for example, from control signals, information elements, or other signals obtained from ones of telemetry sensors 114a-114g. In some examples, the type and form of events and metrics that generate telemetric data and are available in TSS 106 may be dependent on the underlying integrated circuit. The events and metrics may be provided with the underlying integrated circuit in an externally consumable software format for in-band telemetry consumers.

In some embodiments, the sources of telemetry data may include processors, accelerators, network interfaces, and/or any other hardware unit. The sources of telemetry data can further include software entities as threads, tasks, modules, utilities, and/or subsystems. Further, the sources of such telemetry streams for a workload or for a chain of microservices can run on multiple hosts in a cluster, and may further span autonomous execution agents like Smart Network Interface Controllers (NICs), smart-storage, database appliances, etc. The telemetry data may be multipoint multiparty telemetry data, e.g., data of various types, from multipoint multiparty event streams (MMES). Examples of telemetry data in MMES include event logs, block traces, performance monitoring counter (PMC) counts, EBS/TBS samples, system software events, application software generated event streams, and/or any other event stream (e.g., from accelerators, NICs, etc.).

The telemetry data may be streamed in a system using various protocols including, but not limited to, such as the transmission control protocol (TCP), the user datagram protocol (UDP), the QUIC protocol, Extensible Markup Language (XML)-Remote Procedure Call (RPC) (XML-RPC) protocols, and/or the gRPC protocol. In some embodiments, the telemetry data may be streamed using cadence-based and/or periodic telemetry, where data sends information to a collector at regularly configured intervals. Cadence-based telemetry may build historical baselines. In some embodiments, known as event-based telemetry, data sends when a specific event or error occurs, like when a critical link goes down or when the throughput on a link surpasses a specified threshold.

TSS 106 may be implemented as a single memory space or a distributed memory space (e.g., with a contiguous address space, or the like). In some examples, TSS 104 may be implemented as a Static RAM exposed to a memory-mapped input-output space. In some examples, there is a 1:1 (one-to-one) mapping between telemetry aggregator 104 and TSS 106. In some examples, TSS 106 is a flat memory space, which includes all telemetric sensors that telemetry aggregator 102 may use to collect telemetric data.

In some embodiments, telemetry sensors 114a-114g may be intellectual property (IP) blocks of the integrated circuit (or SoCs) in which telemetry architecture 102 is implemented. These IP blocks are communicatively coupled to desired sub-circuits to collect telemetric data. In general, telemetry sensors 114a-114g are arranged to measure certain physical and/or logical phenomena associated with the sub-circuit being monitored. For example, telemetry sensor 114a could be arranged to monitor temperature (using distributed temperature sensing systems), current voltage (using fully integrated voltage rails), bandwidth (using free running counters), concurrency (using counters), droop (using voltage droop method systems), energy (using energy counters), current (using CPU load current monitor), wear out or aging, (using reliability odometers), electrical margins (using double data rate training), errors (using machine check architecture banks), and time in state (using time-in-state residency), or the like. Therefore, examples of the telemetry sensors 114a-114g include, but are not limited to, a temperature sensing system, a fully integrated voltage regulator (FIVR) rail, a free running counter, a counter, a voltage droop measuring (VDM) system, a central processing unit (CPU) current load monitor, an energy counter, a reliability odometer, a machine check architecture (MCA) bank, or a time-in-state residency. It is to be appreciated, that each of telemetry sensors 114b to 114g may be arranged to monitor different physical and/or logical phenomena than that which telemetry sensor 114a is arranged.

Telemetry sensors 114a-114g may share or report the collected telemetric data to telemetry aggregator 104. Telemetry aggregator 104 may store the reported data in TSS 106. With some examples, ones of telemetry sensors 114a-114g report or share the telemetric data through a wireless communication protocol (e.g., Wi-Fi, Bluetooth, Bluetooth Low energy, Near Field Communication (NFC), ZigBee, or the like). In some examples, ones of telemetry sensors 114a-114g may report or share data through a shared data bus, wired communication, or other data communication technology.

With some examples, telemetry interface 112 may provide telemetry consumers 108a to 108c access to telemetry aggregator 104 to retrieve telemetric data stored in TSS 106. For example, access of telemetry interface 112 by a telemetry consumer 108a-108c may require telemetry-specific commands to be sent and decoded on a communication bus of the integrated circuit. The telemetry consumer 108a-108c may be an in-band telemetry consumer or an out-of-band telemetry consumer. Examples are not limited in this context.

Telemetry commands may be mapped onto the existing protocol of the communication bus. As used herein, “telemetry commands” are commands issued by software, firmware, or other sources to discover, access, and configure telemetry data. Examples of telemetry commands may include commands to initiate discovery of the types of telemetry supported by a telemetry aggregator 102, write data to configuration registers of a telemetry watcher 110a to 110c, read the state of a configuration register of a telemetry watcher 110a to 110c, and read the telemetric data stored in TSS 106.

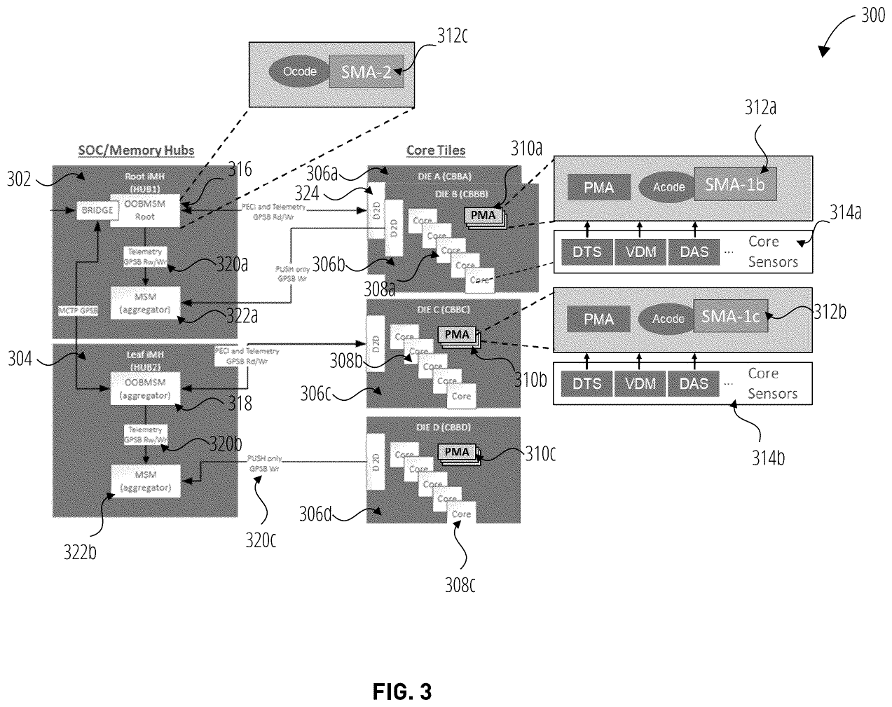

The telemetry watchers 110a-110c allow a telemetry consumer 108a-108c to instruct telemetry aggregator 104 to watch one or more telemetry items (e.g., one or more of the telemetry sensors 114a-114g) along with an associated frequency, any thresholds, and/or alerts to be generated. The telemetry watchers 110a-110c may include Interrupt Configuration Registers, Global Time Stamp Counters, a sampling frequency counter for the selected telemetry sensors 114a-114g, an action counter to trigger an interrupt on any threshold crossings, and a watcher instance ID. Instances of the telemetry watchers 110a-110c are available to consumers via in-band or out-of-band mechanisms. For example, for servers, the interface can be handled by the OOBMSM 316 of FIG. 3 for management component transport protocol (MCTP) and Platform Environment Control Interface (PECI)-based API requests. For host agents, the telemetry watchers 110a-110c may provide an memory-mapped I/O (MMIO) interface (I/F) that translates primary memory and configuration requests to the sideband. In some embodiments, all telemetry watchers 110a-110c are derived from a common base which defines the basic set of configuration and status registers needed to interface with the telemetry watchers 110a-110c. Additional functionality may be provided through extensions to the base or filtering mechanisms attached to the telemetry watchers 110a-110c.

As described in greater detail herein, embodiments provide an embedded AI core to allow the telemetry watchers 110a-110c to build decision logic that can respond timely by dynamically adjusting parameters such as frequency, voltage, software contexts, cooling solutions, etc. Doing so may lead to significantly higher performance and increased efficiency.

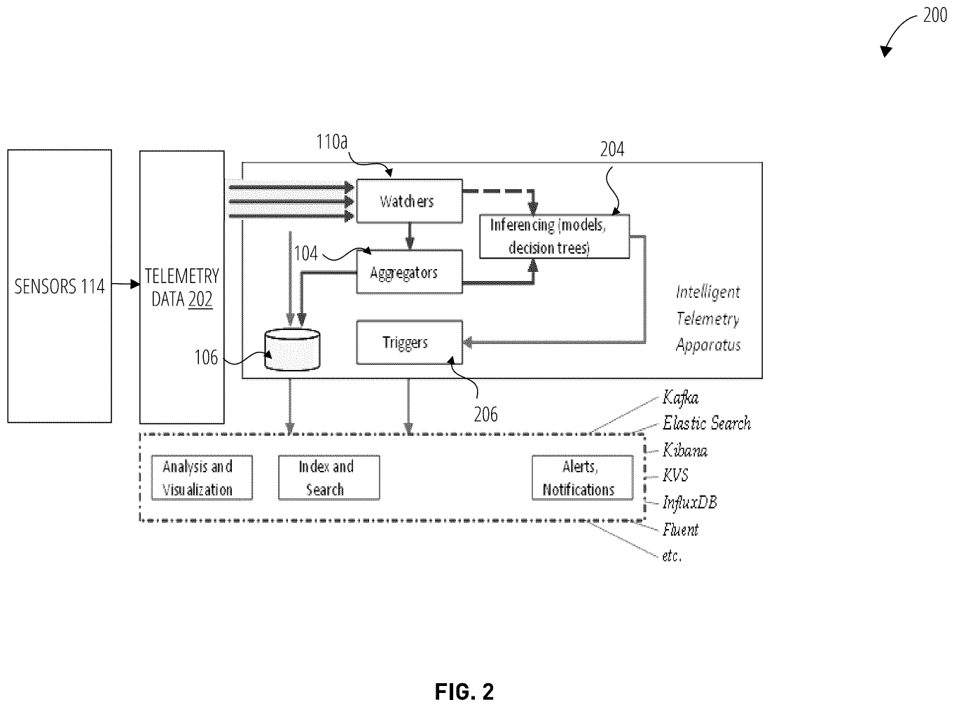

FIG. 2 illustrates a telemetry architecture 200. The telemetry architecture 200 may include the components of the telemetry architecture 102. As shown, telemetry data 202 includes MMES streams generated by the telemetry sensors 114a-114g. The telemetry watchers (telemetry watcher 110a depicted for the sake of clarity) may receive the telemetry data 202. The telemetry watcher 110a may provide the telemetry data 202 to the telemetry aggregator 104 as well as an inferencing component 204. The inferencing component 204 may include models, decision trees, decision forests, or any other software capable of performing inferencing operations based on the telemetry data 202 and the output of the telemetry aggregator 104. The inferencing component 204 may generate one or more triggers 206. The telemetry aggregator 104 may store the telemetry data 202 in the TSS 106 and/or another storage location.

As shown, based on the telemetry data 202 and output of the inferencing component 204, a variety of services may be enabled. For example, services for analysis and visualization, services for indexing and search, and/or services for alerts and/or notifications may be provided. More generally, the services may include services to characterize performance, manage availability and provisioning, isolate throughput, latency, or scaling factors, perform parameter sweeps for optimization, shape or regulate traffic, load-balance, alter software and/or hardware configuration for improving the various figures of merit such as response time, request rates, utilizations, efficiencies, head-rooms, power consumption, etc. Embodiments are not limited in these contexts. One example of telemetry data is In-band Network Telemetry (INT) data supported by the P4 Applications Working Group.

The services supported by the telemetry architecture 102 and telemetry architecture 200 achieve many different goals and reconcile potentially conflicting requirements and service level objectives across multiple parties (e.g., owners of hardware and networking infrastructure, virtual machines and containers, application developers, of systems reliability engineers, software services owners, performance engineers, etc.).

In some embodiments, key performance indicators (KPIs) may be defined for the telemetry data. Doing so may allow, for example, a subset of the telemetry data to be processed. For example, if system temperature is a KPI, but temperatures indicate all sensors are recording normal temperatures, additional processing of the telemetry data may be avoided. If, however, the temperatures indicate abnormal temperatures measured by one or more sensors, the system may further process the telemetry data.

The telemetry data 202 and from the outputs of the inferencing component 204 may be used, for example, to characterize performance, manage KPIs, manage availability and provisioning, isolate throughput, latency, and/or scaling factors, perform parameter sweeps for optimization, shape and/or regulate traffic, load-balance, alter software and/or hardware configuration for improving the various figures of merit such as response time, request rates, utilizations, efficiencies, head-rooms, power consumption, etc.

FIG. 3 illustrates an example apparatus 300 according to one embodiment. In the example depicted in FIG. 3, the apparatus 300 is embodied as a SoC. However, the disclosure is not limited to an SoC, as the apparatus 300 may be any type of computing apparatus. For example, the apparatus 300 may be embodied as a processor, a single die package, a multi-chip module (MCM), a multi-die package, a chiplet, a dielet, a bridge, an interposer, a discrete package, an add-in card, a chipset, or any other computing hardware.

As shown, the apparatus 300 includes one or more integrated I/O and memory hubs (iMH) including root iMH 302 and leaf iMH 304. The apparatus 300 further includes a plurality of core tiles 306a-306d (also referred to as “dies”), each of which is implemented in hardware. Generally, each core tile 306a-306d includes one or more processor cores, each not labeled for the sake of clarity. For example, core tile 306b includes core 308a, core tile 306c includes core 308b, and core tile 306d includes core 308c. The apparatus 300 may generally include or otherwise support the telemetry architecture 102 and telemetry architecture 200.

The root iMH 302 includes an Out of Band Management Services Module (OOBMSM) 316 and the leaf iMH 304 includes OOBMSM 318. Generally, an OOBSM provides capabilities for managing and controlling a computer system remotely, including system monitoring, troubleshooting, configuration changes, and software updates without physically being present at the device. Furthermore, OOBMSM 316 and OOBMSM 318 include management services module (MSM) 322a and MSM 322b, each of which may include software configured to support the OOBMSM 316, and OOBMSM 318, respectively. More generally, the MSM 322a and 322b may aggregate telemetry data generated by sensors 314a and 314b (each of which is representative of the telemetry sensors 114a-114g) of the processor cores. For example, as shown, MSM 322b may receive telemetry data 320c from core 308c via die-to-die (D2D) interface and share the telemetry data with OOBMSM 316. Embodiments are not limited in this context.

Generally, each core tile may include one or more process management agents (PMAs), each of which may be implemented in circuitry, e.g., a controller, microcontroller, etc. For example, core tile 306b includes one or more PMAs 310a, core tile 306c includes one or more PMAs 310b, and core tile 306d includes one or more PMAs 310c. As shown, PMA 310a executes a system management agent (SMA) 312a and PMA 310b executes a SMA 312b. Similarly, OOBMSM 316 executes a SMA 312c. Generally, the SMAs 312a-312c include software (e.g., firmware) that executes on the PMA 310a-310b or the OOBMSM 316 as an execution container. Because SMA 312a and SMA 312b are located on the same core tile as the sensors 314a-314b generating telemetry data, these agents may be considered as “local level” or “core level” SMAs (e.g., SMAs that process telemetry data generated by the associated core). Similarly, because SMA 312c is within the root iMH 302, and communicably coupled to SMA 312a and SMA 312b, the SMA 312c may be considered as a “global level” SMA (e.g., an SMA that receives telemetry data for the entire SoC). As such, FIG. 3 depicts a hierarchical network of SMAs, where different SMAs can communicate with each other, e.g., to share telemetry data and/or the results of processing the telemetry data. In some embodiments, the SMAs 312a-312c may communicate via a bus, such as a general purpose serial bus (GPSB). Examples include an MCTP bus and/or the PECI. Furthermore, the hierarchical network of SMAs is scalable to add additional PMAs and/or SMAs as processing architectures increase in complexity.

Generally, the SMAs 312a-312c may be associated with different configurations, or recipes, where each configuration includes different configurations (e.g., algorithms, parameters, and other associated data) for processing the telemetry data generated by the sensors 314a, 314b. For example, a first configuration may include software algorithms to identify anomalies in the apparatus 300, while a second configuration may include software algorithms to optimize resource allocations for different workloads executing on the apparatus 300. Embodiments are not limited in these contexts, as any possible configuration may be defined. The SMAs 312a-312c therefore act as a signed sandbox with access control mechanisms. The access control mechanisms may be defined at least in part on the respective configurations being used by the SMAs 312a-312c. Example access control mechanisms include the frequency of telemetry data collection, access restrictions to specific telemetry sources, resource control knobs (e.g., to change system parameters), access to statistical hardware accelerators, and/or access to other hardware accelerators. Embodiments are not limited in these contexts.

Each SMA 312a-312c permits system-specific, fine-grained observability for telemetry data and controls that can be enacted at any time interval (e.g., microsecond scale, nanosecond scale, etc.). In some embodiments, SMAs 312a-312c may be customized to operate as basic input output system (BIOS) agents and/or out of band baseboard management controller (OOB-MBC) agents. More generally, each SMA 312a-312c can process the telemetry data faster relative to conventional solutions, as each SMA 312a-312c includes built-in hierarchical controls and hardware accelerators to optimize statistical functions, decision trees, or other functions that can be implemented in hardware, Furthermore, by executing on the PMAs 310a-310c and/or the OOBMSM 316, each SMA 312a-312c container does not perturb the operating environment of the apparatus 300, as each SMA 312a-312c operates independently of the resources of the apparatus 300 (e.g., memory, cache, and/or the cores). Instead, each SMA 312a-312c executes as a sandbox within the microcontroller operating environment (e.g., the PMAs 310a-310c and/or OOBMSM 316) close to where the sensors 314a-314b generate telemetry data.

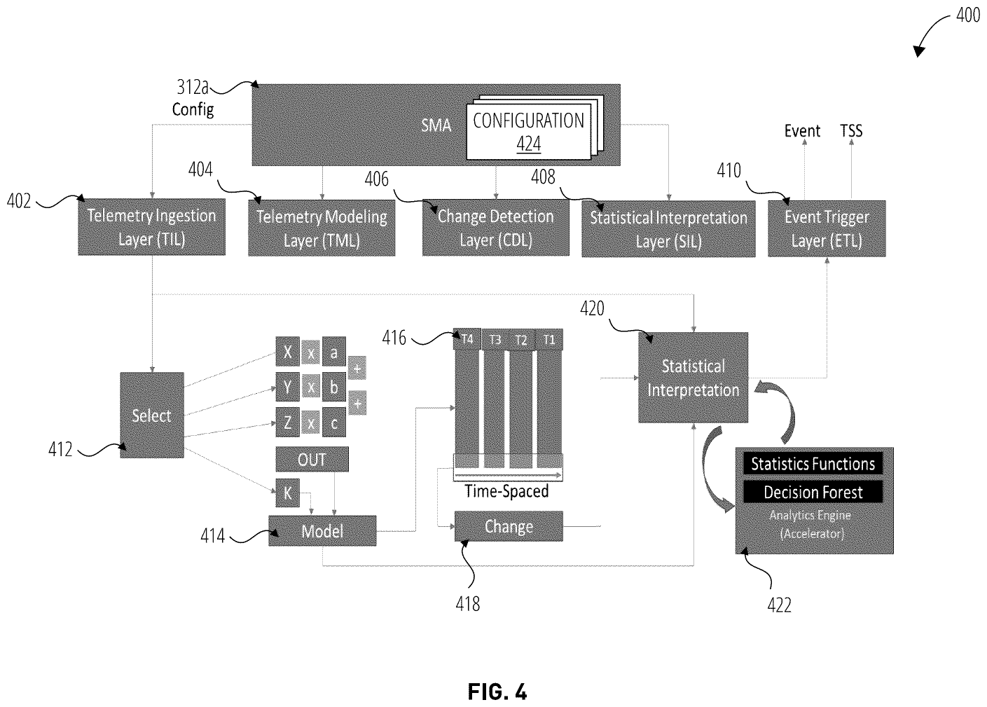

FIG. 4 is a schematic 400 illustrating the components of an example SMA according to one embodiment. Although SMA 312a is the example SMA depicted in FIG. 4, the components of FIG. 4 are included in SMA 312b and SMA 312c. Embodiments are not limited in this context.

As shown, the SMA 312a includes one or more different configurations 424. Each configuration 424 may include software to orchestrate and/or implement the performance of any number of different functions and/or tasks. A given configuration 424 may be provided by a manufacturer of the associated apparatus and/or may be defined by a user. For example, a first configuration 424-1 may be associated with optimizing the execution of cloud microservices, while a second configuration 424-2 may be associated with making a product more reliable. Embodiments are not limited in these contexts.

The configuration 424 further allows any type of customizable function. Example customizable functions that may be implemented in a configuration 424 include, but are not limited to, filtering and processing telemetry features to synthesize customer-specific models, use accelerated (or latency-optimized) statistical function API(s) like change detection and autonomous feature selection, use an accelerated (or latency optimized) analytics engine to enable any classification or regression inference execution (customizing input parameters and outputs of the analytics engine), feeding any custom telemetries output like processed statistics, synthetic model output, and LAE/GAE output to the HOST mailbox (MMIO Space) or Remote mailbox (MCTP Gateway), develop domain-specific language protocols that connects the protocol sandbox (in the execution container of an SMA) through MMIO or MCTP mailbox, dynamic characterization and optimization, including Dynamic Resource Controller (DRC), Memory Bandwidth Adaptation (MBA), cache QoS, dynamic I/O credit allocation, dynamic CPU phase prediction, and/or alignment.

In some embodiments, an SMA such as SMAs 312a-312c may be deployed by uploading the signed EC sandbox for the SMA that contains a custom recipe (e.g., a configuration 424) for telemetry feature selection and information synthesis. A snapshot of the selected CPU telemetry features processed by the CPU EC sandbox (e.g., the SMA 312a, SMA 312b, or a corresponding ACODE extension) may be generated. The snapshot may be provided to the global EC (e.g., the SMA 312c) via a telemetry bus (e.g., the GPSB). The SMA 312c optionally process the telemetry data using classification and/or regression tasks. The output of the classification and/or regression may be further processed by the SMAs 312c. A synthesized model may be generated by the SMA 312c and provided to the MMIO or MCTP mailbox. A host driver and/or remote BMC may collect the output of the synthesized models or processed information and correlates the output to the custom objectives for the configuration 424.

As shown, the SMA 312a includes a telemetry ingestion layer (TIL) 402, a telemetry modeling layer (TML) 404, a change detection layer (CDL) 406, a statistical interpretation layer (SIL) 408, and an event trigger layer (ETL) 410. As such, each configuration 424 may further allow the SMA 312a to configure the TIL 402, TML 404, CDL 406, SIL 408, and/or ETL 410. The TIL 402 is supported by a plurality of application programming interfaces (APIs) to select specific telemetry data from converged telemetry sensors to be presented to SMA 312a as synchronized time-series data streams. In some embodiments, the telemetry data to be selected is specified by the configuration 424 used by the SMA 312a. For example, if the configuration 424 is for detecting overheating, the configuration 424 may specify to select telemetry data generated by temperature sensors. Once data is selected by the TIL 402 at block 412, the selected data is provided to the TML 404. In some embodiments, the TIL 402 may pre-process the selected data prior to providing the data to the TML 404.

The TML 404 provides one or more models 414 with operators to process the selected telemetry data to generate time-spaced output. The time-spaced output is provided to the CDL 406. The model 414 may reduce the telemetry data into values that are being collected over time intervals. Example operations performed by the models 414 include, but are not limited to, arithmetic operations, filtering data, transforming data, interpolation, extrapolation, and/or exponential smoothing (e.g., to predict future values). In embodiments where the same values are predicted by the model 414 over numerous time intervals, the SMA 312a may determine that an associated event has occurred. For example, if the entropy of the telemetry data persists over time intervals, a change may be detected.

The CDL 406 may identify a gap (or difference) between a normal state and a state in which a change to the system occurs. The input to the CDL 406 is a time-spaced vector generated by the TML 404 In some embodiments, however, the TIL 402 provides the time-spaced vector to the CDL 406 without the TML 404 modeling the data. Generally, the CDL 406 may identify the proportion of overlapping data points across different time intervals to identify change at block 418. In some embodiments, the CDL 406 includes a dashboard where telemetry counters (e.g., telemetry data 202) can be used to identify change. More generally, the CDL 406 may use cross-entropy and/or geometric projections to detect a relevant change (and/or a rare event) in a configured time window based on the output of the TML 404 and/or additional telemetry sensors to flag an event of interest.

In some embodiments, the CDL 406 detects change using a similarity measure between the cosine angles of two feature vectors from the selected telemetry data. The similarity measure in the same state (due to an executing workload) may be small (e.g., the cosine angles of similar vectors may be small). However, a state change or uncharacteristic noise may cause the similarity measure to increase above a threshold. If the similarity measure exceeds a threshold, the CDL 406 may detect a change.

In some embodiments, the CDL 406 may detect a change by computing a respective change score for each uni-variate time series in a multi-variate time series of telemetry data. The change score may reflect a mean-shift and may be based on a normalized mean-value difference before and after the event of interest during change detection. To automate real-time feature selection, the SMAs 312a-312c may identify features that maximize the product of the change score and an inverse similarity score or cross-entropy between two distributions. These distributions can represent reference and observed distribution for a given state or two distributions from successive time windows.

The SIL 408 provides various statistical functions to produce interpretable models. As shown, the SIL 408 receives, as inputs, the telemetry data selected by the TIL 402 at block 412, the modeled data generated by the model 414, and the output of the CDL 406 at block 418. The SIL 408 may include the inferencing component 204 of FIG. 2. The SIL 408 may specify conditions (e.g., based on the configuration 424) for data collection, data termination, data transfer, triggers, and/or real-time controls. The SIL 408 therefore performs statistical interpretation 420 using the SIL hardware accelerator 422. The SIL hardware accelerator 422 includes circuitry to accelerate various functions, including but not limited to computing means, computing variance, computing Kurtosis, detecting peaks, O-crossing, computing weighted sums, computing exponential averages, computing an Autoregressive Integrated Moving Average (ARIMA), computing Seasonal/Autoregressive Integrated Moving Average (S/ARIMA), Holt-Winters method for computing triple exponential smoothing, decision trees, and/or decision forests. The SIL hardware accelerator 422 may further include circuitry to accelerate the computation of the similarity measures (e.g., between the cosine angles of two feature vectors). The SIL hardware accelerator 422 may further include circuitry to accelerate the computation of a change score, e.g., based on normalized mean-value difference. The SIL hardware accelerator 422 may further include circuitry to accelerate decision trees, decision forests, marker insertion, and/or time stamp insertion.

The ETL 410 facilitates the generation of notifications (also referred to events and/or triggers) using system or software events and data exchange. For example, the ETL 410 may generate hardware interrupts, custom software events, and/or bursts of synthesized data. In some embodiments, the ETL 410 may generate and perform corrective events. Corrective events include, but are not limited to, modifying hardware configuration (e.g., modifying the operating frequency of a CPU), modifying software configurations, and/or changing the configuration 424 of the SMA 312a, e.g., from a first configuration 424 to a second configuration 424. In some embodiments, the events generated by the ETL 410 are defined by the configuration 424. In some embodiments, other system components receive indications of the notifications generated by the ETL 410. For example, the number of cores in the apparatus 300 may reach the point that fine-grained scheduling cannot be done entirely in software, as the software-based scheduler of the operating system cannot respond quickly enough. Therefore, the apparatus 300 may include microschedulers (also referred to as microtask schedulers) that are implemented in hardware. In such embodiments, the microscheduler may receive event triggers from the ETL 410.

The SMA 312a therefore facilitates interpretable inference using fine-grained telemetry processing at the sensor source and correlates the outcome for root-cause-analysis, power/performance, and reliability validation. Furthermore, custom features can be used for debugging or HW-SW control loops. Without the SMA 312a, it would not be possible to denoise the time-synchronized data, reduce jitter in the data, identify the region of rare events (or relevant regions), or extract trends, seasonality, and operating phases that demonstrate unique characteristics at much finer time scales.

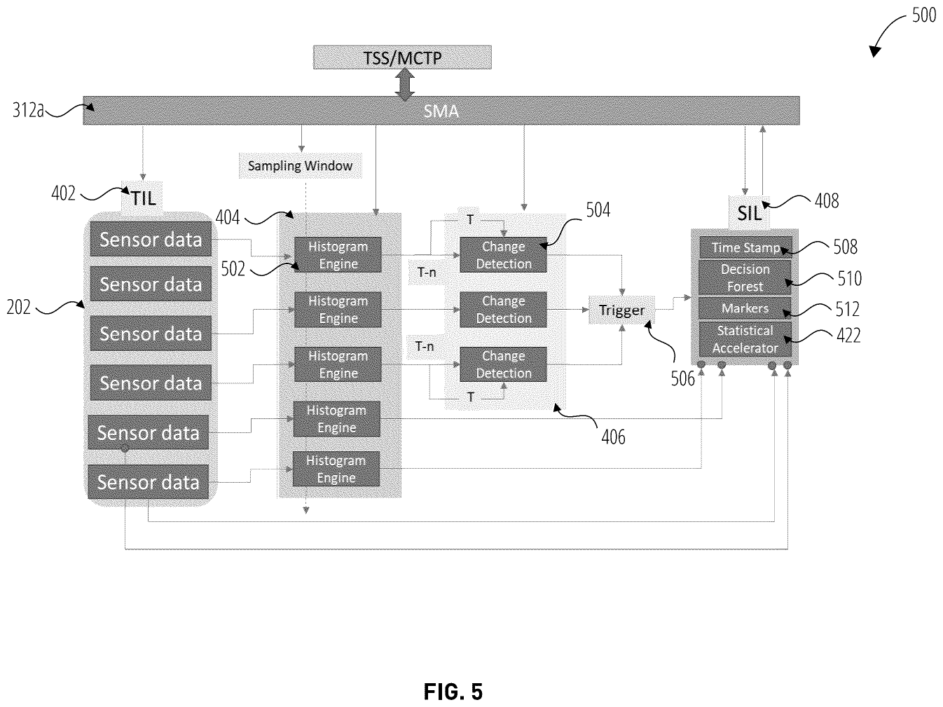

FIG. 5 is a schematic 500 illustrating the components of an example SMA according to one embodiment. Although SMA 312a is the example SMA depicted in FIG. 5, the components of FIG. 5 are included in SMA 312b and SMA 312c. Embodiments are not limited in this context.

FIG. 5 illustrates an embodiment for analyzing telemetry data in a configurable window. For example, as shown, the TML 404 includes one or more sliding-window real-time histogram generation engines 502 for telemetry selected according to the corresponding configuration 424. The histogram engines 502 may be implemented in hardware to accelerate the histogram generation. A histogram engine 502 may be allocated to a group of telemetry counters selected for end-user selection or any autonomous selection based on the configuration 424. Such allocation may induce parallelism for real-time analysis of the statistically significant characteristics of the selected counter (or sensor). While the SMA 312a configures the TIL 402 with the selected group of counters (e.g., one or more portions of telemetry data 202), timely analysis (e.g., change detection) of the time-series data (e.g., by change detection logic 504 of the CDL 406) requires real-time histogram analysis supported by hardware acceleration. Therefore, the change detection logic 504 of CDL 406 may include circuitry to accelerate histogram generation. Generally, histogram generation allows the SMA 312a to analyze mean shift, variance, slope, skewness, change-point counts per time stamp, and/or any other attribute in a streamed manner. The change detection logic 504 of CDL 406 may use the measure of relative entropy of time-gap histograms using the hardware accelerated function of Kullback-Leibler (KL) divergence. The change detection logic 504 of CDL 406 may detect a change based on the “change in the operation phase,” e.g., a rare event or anomaly.

Generally, histogram analysis of the time series data allows the SMA 312a to perform change detection and divide the data into segments whose values each have a similar mean, standard deviation, and/or slope. The reference time window reflects the distribution observed in the past, and the current time window reflects the distribution observed in the most recent data. Change markers also aid in identifying statistically significant counters that can be used, as reduced search surface, for root-cause analysis.

When the change detection logic 504 detects a change, the CDL 406 may generate a trigger 506 which may be provided to the SIL 408. The SIL 408 may receive the trigger 506 based on a “substantial change detection” by the CDL 406. The SIL 408 may then identify the counter with the highest significance using mean/variance analysis. The SIL 408 may collect the telemetry data from the most significant counters for the period of change, where change is defined as the time period of highest entropy or cross-entropy gap relative to previous time periods.

FIG. 5 further shows additional components of the SIL 408. As shown, the SIL 408 includes the SIL hardware accelerator 422, marker insertion logic 512 for inserting markers into the telemetry data 202, timestamp logic 508 for inserting timestamps into the telemetry data 202, a decision forest 510 (including one or more decision trees) for reaching an outcome or decision (e.g., a processor core is overheating, a component is not receiving sufficient voltage, etc.). The markers may be any type of metadata defined by the configuration 424. The decision forest 510 may include a plurality of tests on statistics generated by the SIL 408, thresholds, and/or other parameters to reach a result. More generally, the decision forests 510 may be defined by the configuration 424.

Decision trees included in the decision forests 510 may split data to maximize the information gains criteria, such as entropy and Gini coefficients. Decision trees can process linearly inseparable data and handle redundancy, missing values, and numerical and categorical data types. Several decision trees can be combined to create complex but high-performing random forests that can be used for both classification and regression problems. Developers can assemble and visualize hierarchical finite state machines (FSMs) to model the dynamic behavior for each problem to be solved. The FSMs may be trained and configured using a tool that abstracts the decision tree and deploys the FSM model structure (using programmable registers) using AI tools. Each embedded AI core can have many (e.g., 4, 8, 16, etc.) independent FSMs with dedicated memory and configurations, where the decision output can be fed to a register, decision tree, or interrupt logic. By linking independent FSM logic, developers can model a decision tree into a decision forest. Some decision trees may use thresholds. In some embodiments, a decision tree may be an ensemble tree like e.g., a random forest. Decision trees may be used in CPU phase detection, failure analysis, root-cause-analysis, dynamic-characterization, droop prediction, etc.

In some embodiments, the histogram engine 502 and/or the change detection logic 504 may be time-multiplexed to create large numbers of instances that can then be allocated to the selected counters (e.g., telemetry data 202), as number of these counters can be large (e.g., thousands of counters per core).

By providing the SIL hardware accelerators 422 and the histogram engine 502 in hardware accelerators, associated processing tasks are performed within the window of time in which the data is relevant. For example, by processing the telemetry data 202 via the SMAs 312a-312c, the telemetry data 202 need not be provided to system software, thereby reducing latency. Furthermore, any corrective actions or notifications may be performed during the relevant time window.

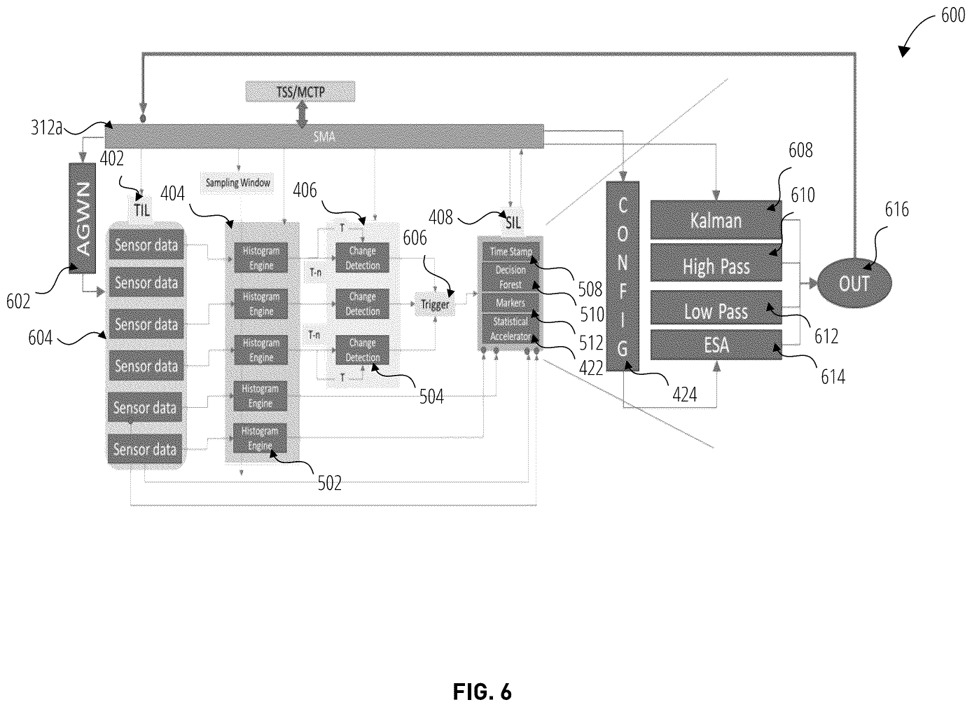

FIG. 6 is a schematic 600 illustrating techniques to denoise and isolate characteristic variations in telemetry data in real-time by a telemetry apparatus such as apparatus 300. Often, telemetry data 202 is noisy, e.g., contains random fluctuations, errors, or interference that makes it difficult to extract meaningful information from the telemetry data 202. The disadvantage of noisy telemetry data 202 is that processing noisy telemetry data 202 may lead to inaccurate or incomplete analysis and reduced reliability which may result in incorrect or suboptimal decision-making.

In some embodiments, the SMAs 312a-312c may effectively denoise noisy telemetry data 202 at the source (e.g., proximate to the telemetry sensors 114a-114g). In some embodiments, filtering techniques, statistical methods, decay factors, smoothing techniques, and/or deep-learning techniques may be used to denoise data as specified by a configuration 424. However, embodiments are not limited in these contexts, as any methods of filtering may be defined by a configuration 424. More generally, the processing by the SMAs 312a-312c may reduce jitter in the telemetry data 202.

Filtering techniques may include the SMA 312a-312c using low-pass low pass filters 612 and/or high-pass high pass filters 610. A low-pass low pass filter 612 may remove high-frequency noise, while a high-pass high pass filter 610 may remove low-frequency noise. Embodiments disclosed herein may select the right filter parameters to avoid altering the dynamic characteristics of the system. Statistical methods may include using Kalman filters 608 and/or Bayesian methods to denoise telemetry data 202. These statistical methods may be used when dealing with non-linear and non-stationary telemetry data 202. The Bayesian approach may provide a probabilistic estimate of the signal, while the Kalman filter 608 may estimate the state of the system in real-time.

Decay factors may include the SMA 312a-312c isolating decay factors, which may characterize how phenomena change over time and establish outer ranges beyond which the effects of anomalies can be assumed to have become inconsequential. Doing so allows an SMA 312a-312c to determine how long it will take for the effects of anomalies to dissipate and for the metric to return to a predetermined range of normal values. In some embodiments, the smoothing techniques include the SMA 312a-312c applying a moving average or other filter to the data to reduce the effects of noise. In some embodiments, the deep learning techniques include training a neural network to learn the underlying structure of the data and remove the noise. This can be done using any neural network, such as autoencoders and/or convolutional neural networks.

Denoising telemetry data 202 may be an iterative process, involving multiple rounds of analysis and filtering to achieve the desired level of noise reduction. The effectiveness of any denoising technique may be evaluated, as removing too much noise can lead to loss of important information. The choice of de-noising parameters may depend on the specific characteristics of the data and the desired level of noise reduction. The parameters must be chosen carefully to avoid over-filtering, which can result in loss of important information, or under-filtering, which can leave too much noise in the data. Embodiments disclosed herein allow the shaping of the telemetry data 202 by iterating the data samples between the telemetry source (e.g., telemetry sensors) and a telemetry sink (e.g., the TSS 106).

In some embodiments, denoising may include defining values for configurable parameters, which may be stored in a configuration 424 of a given SMA 312a-312c. The parameters may include window sizes, cut off frequencies, filter kernels, architecture of the neural network, and/or model parameters. Window sizes may be used for smoothing techniques, such as moving average or low-pass filtering. Generally, the window size determines the number of data points that are used to compute the average or filter the telemetry data 202. A larger window size may result in smoother output, but may also remove important features.

For filters, such as low-pass or high-pass filters, the cut-off frequency may determine the frequency above which or below which the signal is attenuated. A higher cut-off frequency may remove more high-frequency noise, but may also remove important high-frequency features. Filter kernels may define the adjacent portion of the data window and perform mathematical operations on each window, either for smoothing the high frequency components or identifying “edges” where the telemetry data 202 changes the most.

For deep learning-based techniques, the network architecture parameters may include the number of layers, the type of layers, and the number of neurons in each layer. These parameters may improve the performance of the network in denoising the data. For Kalman filtering, the model parameters may include the initial state estimate, the noise covariance matrix, and the system dynamics model. Values of these parameters may balance the removal of noise with the preservation of relevant information.

In some embodiments, the configuration 424 may specify parameters for denoising such that the selected telemetry data 202 are denoised based on the specified configuration 424. The denoising configuration 424 may specify one or more counters storing telemetry data 202 to be denoised, one or more denoising techniques, one or more denoising parameters, and one or more denoising triggers. The selected counters may include counters of telemetry data 202 selected by the TIL 402, modeled telemetry data outputted by the TML 404, and/or be triggered based on the output of the CDL 406 (e.g., an indication of change). The denoising technique specifies one or more denoising techniques, such low-pass filters, high pass filters, Kalman filters, smoothing functions, and/or neural networks. The denoising techniques may be accelerated by the SIL hardware accelerators 422. The denoising parameters may configure the selected technique. The denoising trigger may define one or more conditions upon which the denoising process starts and stops.

In some embodiments, the parameters can be configured as a part of Bayesian tuning until the desired output is achieved. Denoising algorithms may not generalize well to new or different types of noise, or to new data sets with different characteristics. Therefore, each denoising activity may be tuned to one or more objectives, e.g., based on the configuration 424. The ability to tune the statistical filters close to the telemetry source provides the ability to make the telemetry feedback actionable within the real-time bounds.

FIG. 6 illustrates how the SMA 312a may denoise telemetry data 202. As shown, the SMA 312a may configure an Additive white Gaussian noise (AWGN) 602 module to generate random numbers with a Gaussian distribution, e.g., “white noise”. The white noise generated by the AWGN 602 may be added to the telemetry data 202 in real-time, before being processed by the TML 404, CDL 406, and/or SIL 408. The telemetry data 202 with white noise is depicted as the telemetry data 604 of FIG. 6. The telemetry data 604 may then be processed by the histogram engine 502 and/or any other component of the TML 404. The histogram engine 502 may provide insight into the shape of the distribution, the central tendency, and/or the spread of the telemetry data 604 with white noise. By iteratively processing denoised telemetry input with the histogram engine 502, a the statistical properties of the telemetry data 604 may be determined, such as its mean, variance, and distribution. This information can then be used for further analysis, such as identifying trends or anomalies in the data, or making predictions about future behavior.

The output of the TML 404 is fed to the CDL 406 to perform change detection as described herein. The CDL 406 may detect a change and generate a trigger 606. The SIL 408 may then process the trigger 606, the telemetry data 604, the output of the CDL 406, and the output of the TML 404. For example, as shown, the SIL 408 may include one or more Kalman filters 608, one or more high pass filters 610, one or more low pass filters 612, and an ESA 614. The SIL 408 may process the received data using one or more of the Kalman filters 608, low pass filters 612, high pass filters 610, and/or ESA 614 based on the configuration 424. The output 616 of the SIL 408, e.g., at least partially denoised data, is returned to the SMA 312a.

In some embodiments, the SMA 312a determines whether further iterations of the denoising process are required, e.g., based on the triggers defined in the configuration 424 to stop denoising (e.g., based on a threshold level of noise, entropy, etc.). If additional iterations of denoising are to be performed, the output 616 may be returned to the TIL 402 for further processing by the TML 404, CDL 406, and SIL 408.

In some embodiments, the augmented telemetry data (e.g., the output 616) may be used to train the SMA 312a, e.g., to improve its ability to recognize patterns even in the presence of noisy data. Overall, the synthesis of parameterized white noise to auto-augment low-variance telemetry may improve noise-resistant pattern recognition. By introducing controlled amounts of noise to the data, this approach allows pattern recognition systems to better adapt to real-world environments where telemetry data may be noisy or variable.

In some embodiments, a tuning phase uses a probabilistic model, where the algorithm selects the next set of hyperparameters for a model, considering the past performance of the model and the uncertainty in predictions generated by the model. This process may be repeated until a satisfactory set of hyperparameters is found. This tuning may be useful when tuning the sensitivity of the “change detection” and “mean-shift” in the presence of white noise.

Embodiments disclosed herein provide unified and contextualized collection and processing of actionable telemetry from multiple sources with time-varying and non-uniform access control requirements. Embodiments disclosed herein provide automatic labeling of interesting events for efficient and timely filtering/analysis/remediation actions. Furthermore, embodiments disclosed herein provide pinpointing and acting on causes of latency spikes in microservices architectures, and achieve high resolution with dynamic instrumentation in execution spanning multiple hosts.

Therefore, embodiments disclosed herein achieve timely resolution of anomalies, (deliver on optimization opportunities with largely automated/automatable methods, and tap into salient windows over telemetry collections and streamline their extraction and processing with hardware acceleration.

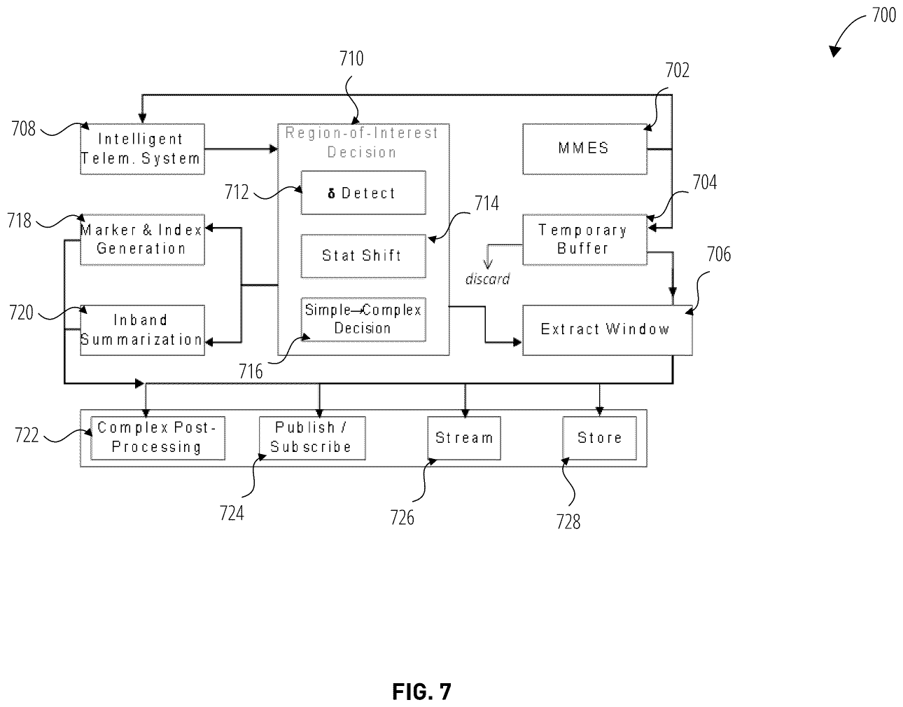

FIG. 7 illustrates a logic flow 700 for secure integration and markup of telemetry data by a telemetry apparatus such as apparatus 300. Generally, the SMAs 312a-312c may dynamically insert markers into telemetry data 202, e.g., using the marker insertion logic 512. The markers may allow security objective-compliant windowing into the telemetry data 202, which may permit less privileged agents to request privacy protected and suitably abstracted metrics over privileged telemetry. Furthermore, the SMAs 312a-312c may implement automatic labeling of interesting events and ranges of interest in telemetry data streams, in association with additional markers over ranges of interest. Doing so may facilitate filtering for high value information and for triggering responsive actions. The timestamp logic 508 may precision time stamp the telemetry data 202, and in-the-flow telemetry aggregation across chains of microservices may allow the SMAs 312a-312c to identify causes of latency spikes.

The SMAs 312a-312c may therefore support distributed collection of metrics and high-resolution time-alignment. The metrics may include stack backtraces and/or logs of instrumentation chosen dynamically on the basis of programmed triggers based on a configuration 424. Doing so may enable telemetry outputs of a distributed system to be treated as that from a single system at microsecond levels of granularity.

More generally, doing so may allow the SMAs 312a-312c to explore and model latent relationships, reduce unexpected behavior, and improve real-time resource tradeoffs at fine-grained levels using AI. Even when dealing with clustered or distributed applications, the automated labeling and indexing into monitored information in real-time and at fine (microsecond-granular) alignment allow many single-system performance diagnosis and characterization techniques to be extended seamlessly to multi-machine systems.

Generally, the logic flow 700 may allow hardware to auto-insert markers in various logs, traces, and/or streaming telemetry data 202. In some embodiments, software that has privileges may use the keys or handles to retrieve the data behind those markers. That data itself can include streams of telemetry data 202, and further, markers in those streams. This allows virtualization of telemetry streams, and natural demarcation points for both security filtering and for aggregation. Furthermore, doing so allows a hardware privilege by which to let various accelerators to consume the information and filter the information, blend the information, aggregate the information, compress the information, map the information, sparsify and/or compact the information, index the information, or otherwise process the information. The logic flow 700 may be part of any compute capable element including smart network, smart storage, the apparatus 300, and/or the system 1800. In some embodiments, the markers inserted by the marker insertion logic 512 include one or more of an ownership key and associated value, a fine-grained timestamp, and/or an integrity signature.

As shown, at block 702, MMES telemetry data 202 is generated by one or more sensors, e.g., telemetry sensors 114a-114g. The telemetry data 202 may be provided to a temporary buffer at block 704, which may discard the telemetry data 202 and/or extract a window at block 706. Returning to block 702, the telemetry data 202 may further be provided to one or more of the SMAs 312a-312c at block 708. The SMAs 312a-312c may then perform region of interest detection on the telemetry data 202 at block 710. As shown, the region of interest detection may include change detection by the CDL 406 at block 712, determining statistical shifts in the telemetry data 202 by the SIL 408 at block 714, and decisioning logic at block 716. The decisioning logic may include determining an event, action, corrective action, etc. A window of interest is extracted from the output of the region of interest decisioning at block 706.

Furthermore, at block 718, the output of the region of interest decisioning and the window extraction is processed by the marker insertion logic 512 to insert markers into the telemetry data 202 and/or generate indices for insertion into the telemetry data 202. At block 720, in-band summarization on the output of the region of interest decisioning and the window extraction. The output of blocks 706, 718, and 720 may then be used for post-processing at block 722, publishing and/or subscriptions at block 724, streaming at block 726, and/or storage at block 728.

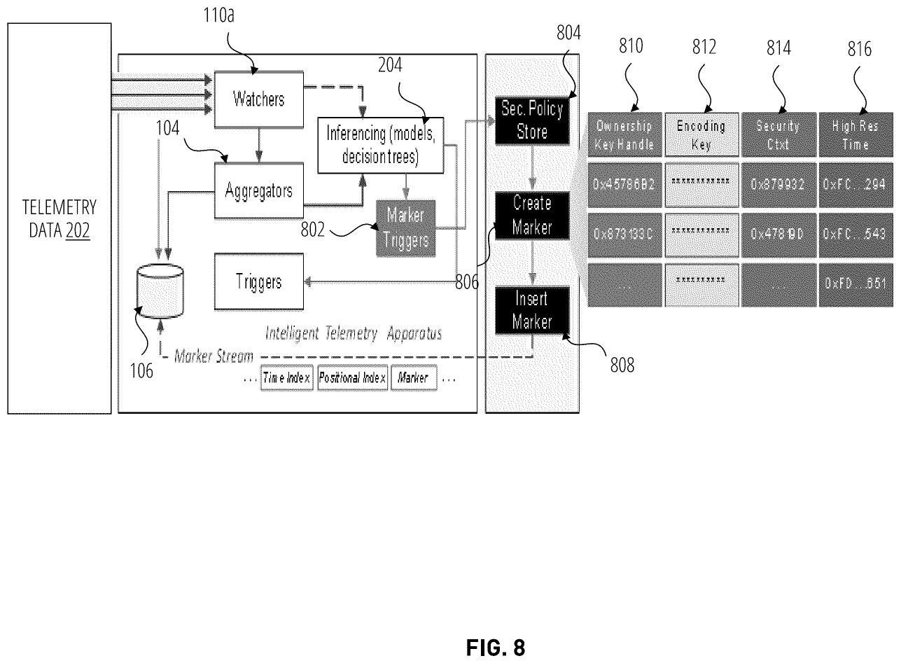

FIG. 8 illustrates techniques for hardware-assisted insertion of isolation markers and ownership transfer markers in telemetry streams of telemetry data 202 in-band with collection of the telemetry data 202 by a telemetry apparatus such as apparatus 300. As shown, the telemetry data 202 may be fed into the telemetry watchers 110a-110c. The telemetry data 202 may include timing data from a high-resolution clock. As shown one or more marker triggers 802 in the telemetry architecture 200 may define conditions for inserting markers. If the output of the inferencing component 204 invokes one or more of the marker triggers 802, at block 804 a secure policy store is accessed to determine one or more markers to be inserted in the data. At block 804, one or more markers are generated by the marker insertion logic 512. At block 808, the markers generated at block 806 are inserted into the telemetry data by the marker insertion logic 512. The markers may be inserted into one or more headers or other portions of one or more data elements communicated via a network and/or bus. In some embodiments, the markers include a time index, positional index, and the marker. In some embodiments, the marked data transmitted and/or stored in the TSS 106 or other storage.

FIG. 8 further illustrates examples of the markers generated at block 806. As shown, the markers may include an ownership key handle 810, an encoding key 812, a security context 814, and a high-resolution time 816 (e.g., a millisecond timestamp, a nanosecond timestamp, etc.). The high-resolution time 816 may be received as part of the telemetry data 202 and/or a time determined based on a local clock when the marker insertion logic 512 is generating the markers. Embodiments are not limited in this context.

The marker insertion logic 512 may leverage a set of common labeling criteria to apply markers. For example, the common labeling criteria may include, but are not limited to, high cycles per instruction with high CPU utilization, low CPU utilization with high response times, and/or a spike in context switches. Doing so may make programming an approximate numerical formula over input parameters easy to do, e.g., based on analyzing /proc and /sys spaces. Furthermore, quantization over the variables entering the numerical formulae and/or comparisons in a decision tree of the decision forest 510 may be supported.

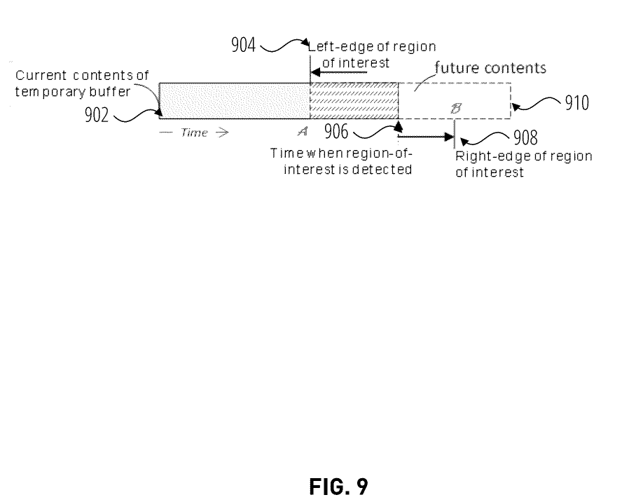

FIG. 9 illustrates techniques for automatic labeling of interesting events in telemetry data by a telemetry apparatus such as apparatus 300, according to one embodiment. To avoid unnecessary processing of telemetry data 202 to determine events and/or processing of the events, embodiments disclosed herein may refrain from performing such processing until some model inference is available that a current time interval is interesting, e.g., that the time interval is part of a range of interest (ROI).

Inputs to the model (e.g., the model 414) may include telemetry data 202 from software counters and/or hardware counters. In some embodiments, telemetry data 202 from more software counters than hardware counters are provided as input to the model. For example, labeling based on hardware counters of interest is one additional action associated with programmed triggering, and capturing the updates coming from software counters requires hardware extensions that monitor various locations. By selecting both types of counters, embodiments disclosed herein permit filtering based on both location addresses and contents of updates.

Furthermore, even when collecting events, traces, etc. on multiple CPUs, it may be that only a span of execution when a small, approximate model/decision-tree indicates that execution on a CPU, a socket, a thread, a process, etc. has entered a region of interest. When a region of interest is entered, an interval of collection on either side of the instant when the signal is received may be provided to a preallocated memory buffer. In some embodiments, a label pointing to the interval may chained into an index, while the trace/telemetry collection is streamed into near-online storage. In some embodiments, a callback is invoked so that software can take immediate notification of the range of interest (depending on the type of interest) for any further action.

For example, as shown in FIG. 9, the temporary buffer contents 902 may store telemetry data 202 from software counters and/or hardware counters. The SMAs 312a-312c may identify a left edge of ROI 904, a time 906 when the ROI is detected, and a right edge of ROI 908, where the ROI is defined by the left edge of ROI 904 and the right edge of ROI 908. Therefore, the ROI may include the telemetry data 202 in the buffer as well as future contents of the buffer (e.g., telemetry data 202 to be subsequently collected).

By supporting change detection as well as relevant event detection, embodiments disclosed herein allow the SMAs 312a-312c to determine that a change occurred based on one or more selected counters, the significance of the change relative to the previous time window or a profiled model, whether there any features that need to be captured if the significant change is a significant change, and/or whether the change is due to regular phase transition or due to irregularity within the phase that is not expected.

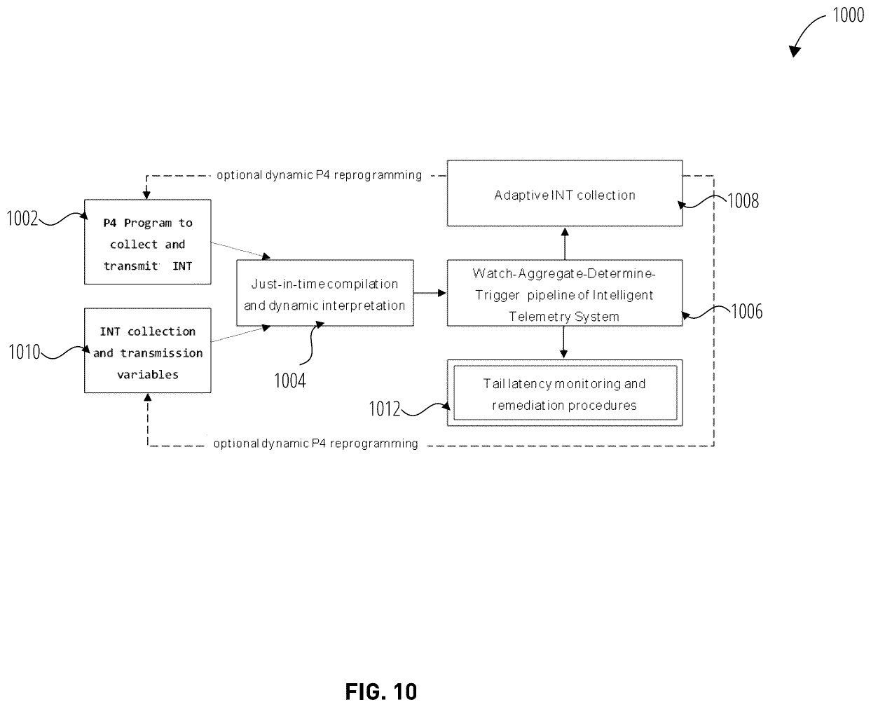

FIG. 10 illustrates a logic flow 1000 for precision timestamps and in-flow telemetry data 202 aggregation across chains of microservices to identify causes of latency spikes by a telemetry apparatus such as apparatus 300. In some embodiments, the roles of telemetry watchers, telemetry aggregators, and triggers are extended into various automation pipelines. Example automation pipelines include, but are not limited to, in-band network telemetry, time-sensitive networking, time coordinated computing, an OS scheduler, and service mesh modules which may be implemented as either libraries or co-processes. In microservices architectures, the latency of a flow from one point to another may be tracked, where the flow may traverse through different VMs, containers, and/or hosts. In such situations, there is no single common handle other than what is inserted through in-band telemetry libraries into packets flowing between network endpoints of the respective services through which the packets/messages move from point source to destination. In general, special service mesh elements like splitters and joiners may be used to split or merge the handles tracking a particular flow according to where subsidiary flows arise.

In-band network telemetry may include adding various metadata per packet to collect hop-by-hop statistics about packet flows and any other fine-grained statistics added into source to destination flows by in-transit entities (including any computation that may be performed by such entities). Often, these entities may include microservices. However, headers and the metadata that can be added for telemetry collection may not be fixed. Indeed, in some embodiments, a flow compiler may abstract the in-band network telemetry capability and presents it as an API to the network stack, to communicating applications, and/or to the intelligent telemetry apparatus (e.g., apparatus 300). This may automate the extension of intelligent telemetry, marking, and detecting of regions of interest to packet flows and to higher level protocol processing among microservices. In some embodiments, in-band network telemetry may be used with general telemetry collection so that if some event of interest transpires at a first point in time, then the region-of-interest extraction not only logs and/or forwards the event details to an analyzer, but may also insert into the same flow, headers and/or metadata so that a second pattern detector at a second, subsequent point in time, also collects additional, correlated data headers and/or metadata correlated to the first point in time.

While this can be done in software, the granularity at which it can be done, and the overheads of processing can easily become excessive. By extending the role of watchers and aggregators (and subsequent triggers) into packet and message processing stacks, embodiments disclosed herein make in-band network telemetry more hardware-friendly while also keeping it flexible because the desired paths and payload parsing can be compiled down from software into hardware instructions for what to monitor and how to filter. Indeed, the role of precision time (in microsecond granularity) through fine grained coordination between PCIe timestamping mechanisms and cycle timestamps readable at nanosecond granularity by instructions have been used in highly time-sensitive and time-coordinated computing, and in this case, the same precision is available for including into the in-band network telemetry markups for processing at telemetry watchers and telemetry aggregators.

As shown, the logic flow 1000 may include, at block 1002, generating a program to support in-band network telemetry data. The program may generally include code to collect, transmit, receive, and/or otherwise process in-band network telemetry data. While the program may be generated using higher-level programming languages, a compiler may compile the program to generate hardware instructions executable by a computing device such as a network appliance (e.g., router, switch, bridge, etc.), compute node, and/or virtualized device. For example, the hardware instructions may include instructions for what types of data to monitor (e.g., telemetry data 202) and how to process (e.g., filter) the monitored data. The generation of the executable code may therefore include, at block 1004, compilation of the program to generate the hardware instructions for dynamic interpretation of the in-band network telemetry data. The computing device may then execute the hardware instructions to perform dynamic interpretation of the in-band network telemetry data. Generally, doing so allows the computing device to collect, analyze, or otherwise process in-band network telemetry data.

At block 1006, one or more telemetry pipelines disclosed herein may execute in one or more intelligent telemetry systems (e.g., the apparatus 300). At block 1008, the devices executing the instructions generated at blocks 1002 and 1004 may perform adaptive in-band network telemetry data collection. For example, a computing device may determine which types of data to monitor, monitor the data, and process the monitored data. At block 1010, variables for in-band network telemetry data collection and/or transmission are determined based on the collected data. The parameter values may be determined by the SIL 408 and/or any other model. Doing so allows the recompilation of the program at block 1004. The program may be recompiled any number of times as more data is collected and/or as the program is updated. In some embodiments, the program may be reprogrammed dynamically based on the variables determined at block 1010. In some embodiments, the program is dynamically reprogrammed and/or the variables are determined at block 1010 using generative AI.

Returning to block 1006, the logic flow 1000 may include, at block 1012, performing one or more monitoring and/or remediation procedures. For example, corrective actions may be performed, trigger notifications generated, etc.

In some embodiments, service mesh elements may keep higher level software free of in-band network telemetry details and can work with new hardware drivers directly (expanding the role of service mesh modules). In some embodiments, OSes may provide high resolution timestamps into these flows, by automatically capturing the time that threads move onto run queues and from run queues into dispatch, so that precise accounting can be obtained for where latencies build up.

In a distributed workload, the collection of hosts becomes a single system from the standpoint of collecting correlated monitoring data, aggregating, and analyzing the telemetry, and driving forward tasks and generating feedback for telemetry collection and aggregation operations. In general, signaling and data distribution for telemetry operations may be both fine grained and low latency even under durations of peak volumes of telemetry traffic, while also ensuring very low (microsecond-granular) latencies under non-peak conditions. This may be provided by at least one dedicated multicast UP channel which is given high priority for transmission and reception, and backing it with pre-allocated pinned down memory areas into which telemetry data and signals can be streamed is a solution that can be scaled down to foundational NICs. Furthermore, OS and networking drivers may implement high priority, preemptive scheduling for per-host software agents that need to pool, aggregate, and/or distribute telemetry data. Further still, the hosts that form a collective system over which a distributed application is monitored, may be organized into hierarchical collections so that monitoring data is shared and aggregated in parallel-pipelined manner. New topologies may be created and operationalized on the fly when there are network partitions or when there is some non-permanent outage at a node or in a node's networking system.

Embodiments disclosed herein provide techniques for adapting collection and processing of actionable telemetry to time-varying needs. Embodiments further provide for automatic collection of corroborating data to increase confidence in inferences arrived at with models. Embodiments provide efficient and timely multiplexing of a limited number of hardware performance monitoring resources. Embodiments further provide techniques for tying collected telemetry, inferences, and, telemetry-to-be-collected, into a tight closed loop. Doing so may automate the discovery of emergent behaviors of systems and adapt to them without being concerned with overheads and latencies for such automation and adaptation.

As stated, energy-efficient non-invasive telemetry systems may minimize the movement of telemetry data and takes it through various common programmable actions at low latency. With some embodiments, an architecture combines flexible, lightweight, and adaptive monitoring at near real-time with customized filtering and triggering actions. Doing so provides proactive and agile adaptation of performance monitoring unit (PMU) counters and processing, thereby extending actionable telemetry embodiments to perform dynamic selection and multiplexing of limited PMCs to cover priority events on a continuous basis. Some embodiments may timely pause and resume collections and create delta fingerprints in which intrusive collection is taken up surgically and prioritized judiciously with agility. In some embodiments, provisions for automatic corroboration of automated inferences are provided such that confidence in automated inferences can be obtained before acting on their basis. In some embodiments, a match-action pipeline for even faster situational adaptation whereby ML/DL based steering can be combined holistically and precisely with regular expressions based, stateful condition evaluation.

While the number of potential events to track continues to increase rapidly, the number of hardware collection resources such as performance monitoring counters goes up very gradually. This is coupled with an increasing urgency to obtain various types of ratios (like cycles per instruction (CPI), memory references per instruction (MPI), etc.) and their rates of change at fine time intervals.

Further, these ratios and their rates of change have to be smoothed, thresholded, etc., to eliminate outliers, to identify centerline trends through exponential averaging, to detect transitions in computation conditions and phases, and/or to adapt monitoring to such transitions in an agile manner. This translates to repurposing the limited number of collection resources from tracking previously determined events of interest, to new events of interest as transitions are sensed. Alternatively, it translates to increasing or decreasing the granularity at which different events are tracked so that the counting resources can be multiplexed differently during periods of steady state compared to periods of higher entropy. Also alternatively, it translates to changing the types of aggregation (filtering) on the collected telemetry.

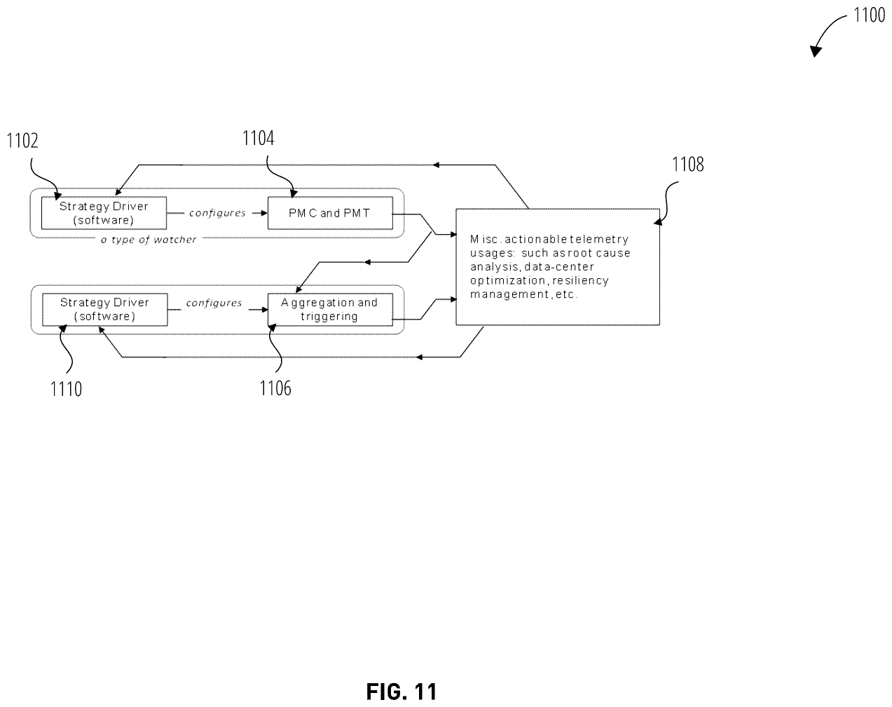

FIG. 11 illustrates a logic flow for adapting a telemetry apparatus such as apparatus 300, according to one embodiment. Embodiments disclosed herein may provide a software “harness”, e.g., the strategy driver software depicted in FIG. 11. At block 1102, the strategy driver software may configure a monitor such as PMC and/or a platform monitoring technology (PMT). Collectively, the strategy driver and the PMC and/or PMT may be a telemetry watcher 110a. Generally, the strategy driver may program the collection and routing of PMC and PMT events at block 1104. At block 1106, the strategy driver may configure aggregations and/or any signals to be triggered by the PMC and/or PMT on the basis of aggregated metrics.

At block 1108, the results of the monitoring, aggregation, and/or triggering may be used. For example, root cause analysis, data center optimization, etc., may be performed at block 1108. The results of the processing may be used by the strategy drivers to alter the collection, aggregation, triggering and routing in each forward interval. For example, the strategy drivers may be reprogrammed and/or otherwise reconfigured based on the monitoring, aggregation, and/or triggering and/or the use thereof at block 1110. This loop may be repeated iteratively as needed.

Different usages may require different scripting of strategies. The following is an example of different configurations for monitoring and configuring a workload:

As shown, a workload may be launched in a cloud computing center. The top portion of the example reflects the strategy driver configuring the PMC and/or PMT to monitor the number of actual CPU cycles and/or a number of instructions returned during execution of the workload.

For example, after a first iteration of the logic flow 1100, a CPU frequency drop and/or a rise in cycles per instruction may be detected (e.g., based on the strategy driver configuring the PMC and/or PMT to monitor the number of actual CPU cycles and/or a number of instructions returned). As such, the strategy driver may shift to a different strategy (“strategy 1” in the above example) in which event counts for establishing intense instructions that reduces available CPU are counted. These event counts may include causing the PMC and/or PMT to collect data for reference clocks, numbers of actual CPU cycles used, counts of instructions returned, a license level, a count of advanced vector extension instructions returned, and/or a count of advanced matrix extension instructions returned. After the PMC and/or PMT collect additional data according to the different strategy (e.g., based on another iteration of the logic flow 1100), the strategy driver may shift to another strategy (“strategy 2” in the example) which seeks to rule-in or rule-out branch mispredictions and/or L1 data cache misses as a factor for the rise in CPI. In such an example, the strategy driver may multiplex data collection by the PMC and/or PMT by counting a number of L1 cache references, a number of L1 cache misses, a number of instructions returned, a number of actual cycles used, and/or a number of branch mispredictions. Embodiments are not limited in these contexts.

Changing strategies may require frequent checking, transformation, and/or transmission of monitored information from various registers, data structures, etc., into memory variables used by the strategy driver. These transitions may cost machine overhead which may limit how frequent the strategy changes can occur, as the latency build-ups that occur in each transition may limit the precision with which a strategy can detect boundary conditions and respond to them (e.g., the reaction time is bounded by such latencies).

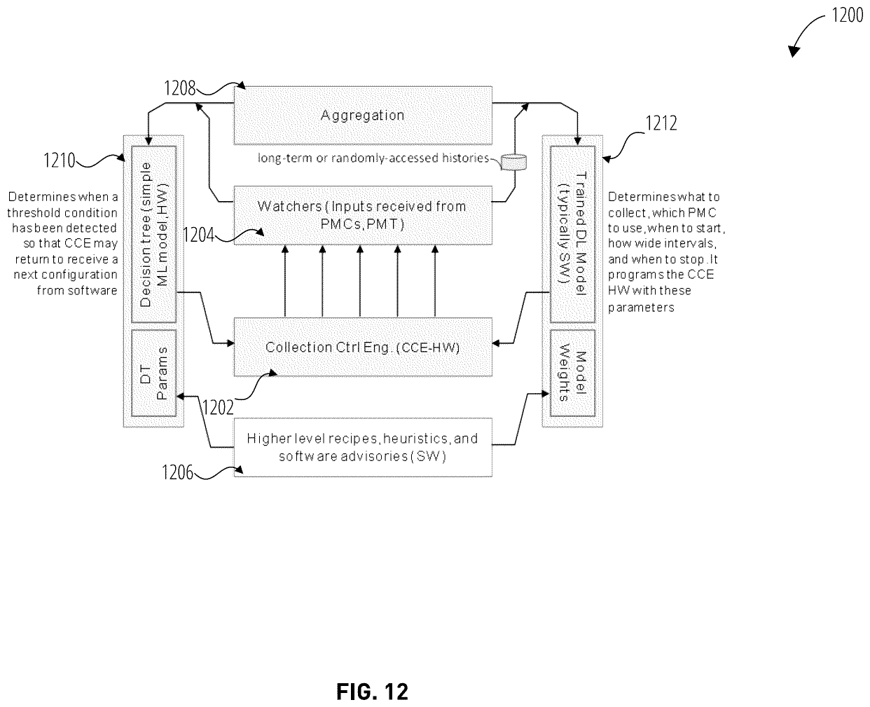

These issues may be resolved using model-driven telemetry. FIG. 12 illustrates a schematic 1200 for model-driven telemetry in a telemetry apparatus such as apparatus 300, according to one embodiment. As shown, the schematic 1200 includes a collection control engine (CCE) 1202, one or more watchers 1204 (which may be telemetry watchers such as telemetry watchers 110a-110c), an aggregator 1208, software 1206 for higher-level configurations (e.g., configuration 424), a decision tree (DT) 1210, and a recommendation model 1212.

The CCE 1202 may be implemented in hardware and may include circuitry for receiving and acting on instructions from the recommendation model 1212 and/or the DT model 1210. The instructions received by the CCE 1202 may include at least two types of instructions: (a) a “next-iteration” signal, e.g., that collection is at an internal transition point for multiplexing between event collections determined as part of a current strategy which comes from the component DT model 1210, or (b) new strategy recommendation from component the recommendation model 1212.

The recommendation model 1212 may be a deep-learning hardware neural and memory circuit which may execute a software strategy code. The recommendation model 1212 may generate recommendations to shift to a particular strategy using programmed hardware logic that keeps track of continuously aggregated state. The software strategy code may operate on variables without requiring transmission or transformation (directly fed from the aggregator 1208, which may be a telemetry aggregator 104). This the recommendation model 1212 may define specific event masks, multiplexing schedules, and/or transition conditions to be detected by the DT model 1210.

The DT model 1210 may include one or more decision trees that may be programmed by the recommendation model 1212. Therefore, the recommendation model 1212 may process a phase-based collection of relevant counters in the telemetry data 202 which may contribute to some objective in a given phase proceeds while phase demarcation (or phase-change detection) that is based on some common observables (e.g., CPI, MPI, etc.) is instrumentalized by the recommendation model 1212. The software 1206 may include procedures to configure the recommendation model 1212 and/or the DT model 1210. The software 1206 may further create the overall scheme for strategies to be followed and to configure various parameters that may be used by the recommendation model 1212 and/or the DT model 1210.

Therefore, the model-driven telemetry embodiments permit gradual transitions from one multiplexing strategy to another strategy by continuing observability over other events that may have lower priority but may be needed to confirm that a system/element is still in a given phase. For example, collecting CPI and MPI at a coarser granularity may ensure that execution has not veered off into a different phase, while one is collecting a few front-end counters frequently to get better precision in profiling for front-end stalls coming in a given span of execution.

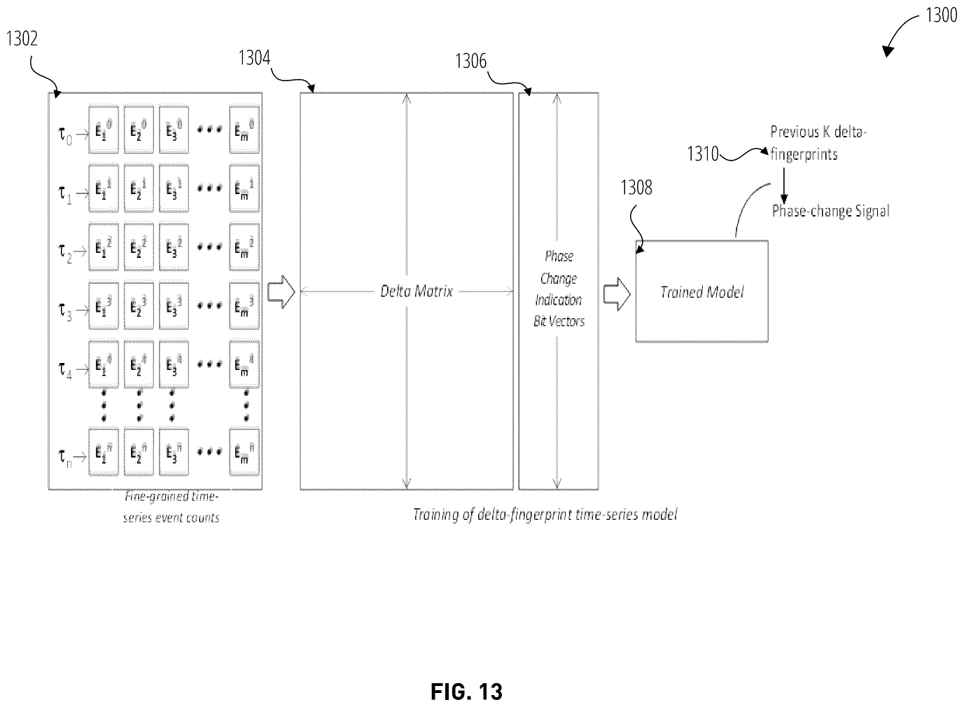

In some embodiments, delta-fingerprints that precede phase changes may be trained using machine learning. Once trained, these fingerprints may be used to select priorities and schedules among events to be collected for an incoming (e.g., subsequent) phase as depicted in FIG. 13.

FIG. 13 depicts a logic flow 1300 for training and using such a model, according to one embodiment. As shown at block 1302, fine-grained time-series event counts (e.g., counts of events based on telemetry data 202) may be received. The time-series data may include telemetry data 202 and/or any output of any component of the SMAs 312a-312c. At block 1304, a delta matrix is generated based at least in part on the time-series data received at block 1302. At block 1306, one or more bit vectors reflecting indications of phase changes may be received. At block 1308, a machine learning algorithm may be used to generate a trained model based on the time-series event counts, the delta matrix, and/or the bit vectors. The trained model may then be used at block 1310 to generate a phase change signal as new phase change fingerprints are received by the model. Doing so may cause a shift between one strategy to another, e.g., from strategy 1 to strategy 2 in the above example.

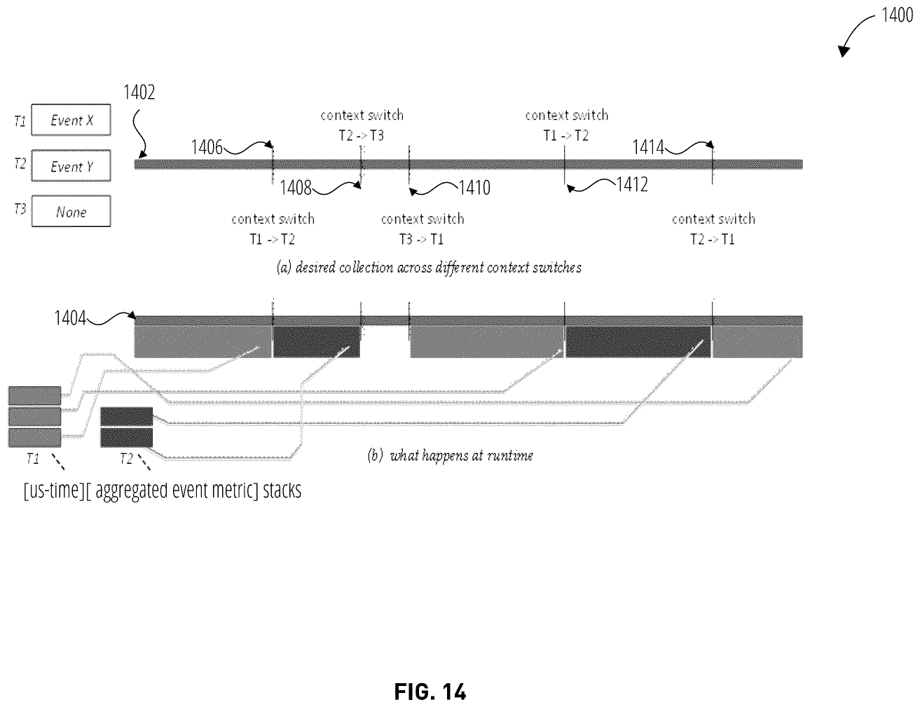

In some embodiments, the CCE 1202 may initiate, pause, and/or terminate the collection of telemetry data 202. In some embodiments, such decisions may be based on an analysis of conditionally and/or unconditionally collected telemetry data 202 or other metric data. FIG. 14 illustrates a schematic 1400 of the CCE 1202 managing the collection of telemetry data 202, according to one embodiment.

As shown in FIG. 14, a timeline 1402 may reflect the collection of telemetry data 202 and/or other metrics over time, while timeline 1404 reflects the operations performed during runtime. For example, at time 1406, a context switch may occur, e.g., where a processor switches context from an example thread x to an example thread y. Prior to the context switch at time 1406, the CCE 1202 may collect data for thread x. However, at the context switch at time 1406, the CCE 1202 may pause the collection of data for thread x and cause data for thread y to be collected. Similarly, the CCE 1202 may detect a context switch at time 1408, e.g., from thread y to no thread (e.g., neither thread x nor thread y is executing on the processor). Based on the detect context switch at time 1408, the CCE 1202 may temporarily stop collecting metric data for thread y. Similarly, at time 1410, the CCE 1202 may detect another context switch from no thread to thread x, and collect data for thread x. At time 1412 the CCE 1202 may detect a context switch from thread x to thread y. As such, the CCE 1202 may stop collecting data for thread x and resume collection of data for thread y. Similarly, at time 1414, the CCE 1202 may detect a context switch from thread y to thread x. As such, the CCE 1202 may pause the collection of data for thread y and resume collection of data for thread x.

The CCE 1202 may make the changes as the need arises, e.g., when there is a need to collect a wide range of data from the PMU and/or a processor trace (e.g., the Intel processor trace (IPT)). The CCE 1202 may implement such context switches in a non-intrusive way, e.g., by pausing and resuming collection directly from one or more of a control program (e.g., in the extended Berkeley Packet Filter (eBPF)), a scheduler, and/or any other runtime software at relevant time points, e.g., time 1406, time 1408, time 1410, time 1412, and/or time 1414. For example, the CCE 1202 may perform the switching in hardware directly from hardware sensed events such as the processor writing to a control register which signals a context switch or by writing a new model-specific register (MSR) at any time from any layer in software.

The CCE 1202 may automatically program masks so that telemetry counter resources are multiplexed economically for suspend-resume use cases, (or any other use cases). Thus a single counting resource (e.g., a non-fixed PMC) can be used to count different events according to previously saved and now restored mask values, while automatically pushing a previously collected count onto a hardware stack. In some embodiments, there may be some constraints such as the depth of the stack that is supported in a given version of the hardware.

In some embodiments of software guided management of collection, the CCE 1202 may synthesize (e.g., the PID value of telemetry data) as additional telemetry input. The collection of native telemetry and the synthesized telemetry can act as input to the CCE 1202 that manages (e.g., starts or pauses) the relevant telemetry collection. Whether software explicitly collects, or whether a programmed model (e.g., the recommendation model 1212) causes collection through auto-selection based on such detections as statistical variations (e.g., mean, variance, etc.) is also indicated alongside collected telemetry (e.g., through a log or some other data structure). The CCE 1202 may create a flag that indicates “this telemetry block of collected data is consumed and the CCE 1202 is ready to receive the next block.” Conditions may include statistical conditions or based on derived classes through a decision tree output. In some embodiments, telemetry data does not remain in CCE 1202 for long. For example, the CCE 1202 may push the collected data to the MMIO or MCTP bridge so that the host can collect and save the data for further analysis.

As stated above, embodiments support closed-loop analysis with hardware-supported filtering, leading to aggregation, and simple decisions in hardware. These decisions may launch the collection different events for further analysis. Because such decisions may be based on statistical inferencing, some erroneous decisions may be reached. To achieve high confidence in such decisions and proceed with remedial actions, embodiments disclosed herein may collect new telemetry quickly and/or contemporaneously with such decisions to act as a confirmation test.

The following table illustrates an example of an automated inference for a decision followed by collecting data to confirm or otherwise corroborate the inference:

| | |
|---|---|
| Automated | High CPI due to high translation lookaside buffer |
| inference: | (TLB) miss rate |
| Confirmation | 1. Collect #page-walk-cycles during high CPI |
| telemetry for | execution. |
| corroborating | 2. Create stress on L1 cache by scheduling a TLB- |
| the inference: | friendly L1 stressor on sibling threads. This is to |
| | check that the high CPI is not made even higher due |
| | to L1 pressure. |

Therefore, as shown, the collection of the number of page walk cycles and the stress creation on the L1 cache may be used to support the inference that high TLB is resulting in high CPI. In some embodiments, the creation of stress on the L1 cache is performed by the actionable telemetry system. In some embodiments, the creation of stress on the L1 cache may not be part of actionable telemetry itself, but may be produced by a utility that is created in advance by higher level software. By confirming the inference within a few milliseconds of detection, higher level software may launch further collections for various diagnostics (beyond just hardware event counter readings).

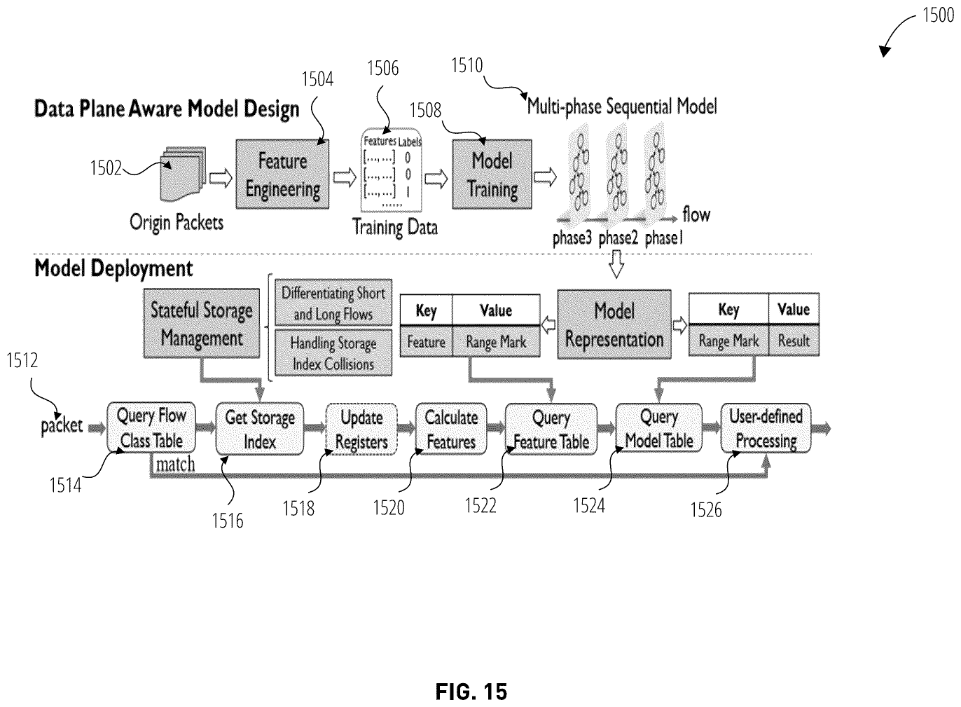

FIG. 15 depicts a logic flow 1500 for a match-and-act pipeline (MAP) for autonomous, hardware-based telemetry strategy shifting at fine-grained time intervals, according to one embodiment. The MAP may be applied to actionable telemetry in any computing device, such as the apparatus 300, a networking apparatus, virtualized networking apparatus, and the like. For example, the MAP application to actionable telemetry may be implemented in a smart NIC. Embodiments are not limited in this context.

Generally, to apply MAP to actionable telemetry, a markup of collected telemetry data 202 may be presented to hardware in the same way that NIC MAP operates on network packet header data. Thus, well-defined (e.g., according to telemetry schemas) telemetry data payloads in one or more packets are filtered through a MAP pipeline. In the MAP pipeline, and matches may be identified over event counts data and/or or code addresses and last branch record (LBR) addresses (e.g., stack matches). These matches may be performed by hardware configured to detect matches between packet data (e.g., classifications, comparisons, and/or other logic). For example, the hardware may be configured over programmed match-expressions which may include comparison operations (e.g., greater than, less than, equal to, etc.) and/or regular expressions. The regular expressions may be applied to telemetry-driven actions to combine the ML/DL model-driven adaptation of collection with that driven by highly flexible and extensible procedural logic.

Therefore, for example, the MAP pipeline may allow hardware to implement various functions based at least in part on telemetry data 202. For example, a networking device implementing the MAP pipeline for telemetry data may determine that, if a packet is within a this code path, and if the CPI of the processor over the last N instructions is greater than a threshold, to perform a predetermined operation.

As shown, FIG. 15 reflects a training phase including block 1502, where one or more data packets that include telemetry data 202 are accessed as training data. At block 1504, feature engineering may be performed to define one or more features for training the model based on the training data. At block 1506, the training data may be prepared based on the features. At block 1508, the model is trained based on the prepared training data and a deep learning algorithm. Doing so may generate a trained multi-phase sequential model at block 1510.

At block 1512, a packet may be received at a networking device. The networking device may include some or all of the components of telemetry architecture 102, telemetry architecture 200, and/or telemetry apparatus 300. At block 1514, the networking device may process one or more portions of the packet (e.g., source Internet Protocol (IP) address, source port number, destination IP address, destination port number, protocol, etc.) to a query flow class table. Based on a detected match, at block 1516, the networking device may receive a storage index based on the match from stateful storage management. The stateful storage management may include logic for differentiating different flow types (e.g., long flows, short flows, etc.) and handling storage index collisions. At block 1518, the networking device may update one or more registers based on the storage index. At block 1520, the networking device may compute one or more features of the packet based on the features defined at block 1504.

At block 1522, a feature table is queried based on the features of the packet computed at block 1520. The feature table may be based on the trained model of block 1510. Doing so may return a feature value as a key and a range mark as an associated value. At block 1524, the networking device may query a model table of the model trained at block 1510 based on the results returned from the feature table at block 1522. Doing so may return a range mark as a key value and an associated result value. At block 1526, user-defined processing may be performed, e.g., to perform an action or other associated operation. The user-defined processing may be based on the results of blocks 1516-1524 as well as the packet itself. Embodiments are not limited in these contexts.

Some embodiments include understanding and responding to memory needs of multiple applications executing on shared hardware. The applications may be independent but may cause noisy-neighbor effects among each other. Such effects may arise from page cache sharing. In some embodiments, the applications may not be independent, and the applications may be part of a collective (e.g., a chain of microservices and/or a process group) which can benefit from collective management of capacity. For example, when applications are part of a process group, and their overall functioning together is a target for performance optimization, it may be beneficial when a first application that has less need for page cache capacity can release one or more of pages and thus make the released pages available to a second application with a higher relative need for the pages. More generally, any other cooperatively sharable capacity—not just in page caches, can also be balanced with similar techniques, so the concept and mechanisms may be extended to other cooperatively shared resources (e.g., processor cores, accelerator devices, I/O devices, etc.). To do so, in addition to having fine grained and real-time processed telemetry over page accesses, buffer usages, etc., embodiments disclosed herein facilitate communication through a very lightweight, hardware-comprehended bidirectional means between users of memory (e.g., applications) and managers of memory (e.g., OS kernel, runtime memory, slab management services, etc.). Embodiments disclosed herein include solutions that can be implemented in hardware and/or software (e.g., OS or other runtimes).

Embodiments disclosed herein provide an energy-efficient, non-invasive telemetry system (e.g., the apparatus 300) that may minimize the movement of telemetry data 202 and moves the telemetry data 202 through various common programmable actions at low latency. In some embodiments, a mechanism to communicate needs/intents/hints/requests-for-access-stats over pages through a bitmap is provided. Furthermore, the telemetry system and the OS which uses the telemetry system are configured to communicate the results, constraints, and telemetry data 202 through a bitmap in the reverse direction. Bitmaps may be placed directly in software addressed regions of address space so that it is not necessary to use expensive system calls or I/O channels to pass the information back and forth. The bitmaps in either direction may be generated by an Interface Definition Language (IDL) compiler. In some embodiments, the parameters of invoking the use of bitmaps for passing directives or requesting results are changeable at run time, thereby allowing seamless, self-managed and quickly-reactive behaviors to be programmed into applications.

Embodiments disclosed herein therefore provide efficient and adaptive use of performance monitoring resources in hardware, particularly for scheduling the use of memory on a reactive basis. Memory capacity may be a constraint in how effectively the full utilization of a machine's available computational throughput may be realized. Many large tenants in cloud infrastructures who may pay premium costs and may provision large CPU count instances to ensure sufficient memory is available to run their applications. Doing so may result in difficulty in raising CPU utilization above 50%. By providing the ability to burst up or scale down memory usage on a dynamic basis, cost and/or resource savings may be achieved. Furthermore, doing so may allow applications to use the right amount of memory for the right durations of time, on a continuous basis (e.g., not requiring application restarts and/or running disruptive garbage collection mechanisms at the wrong time).

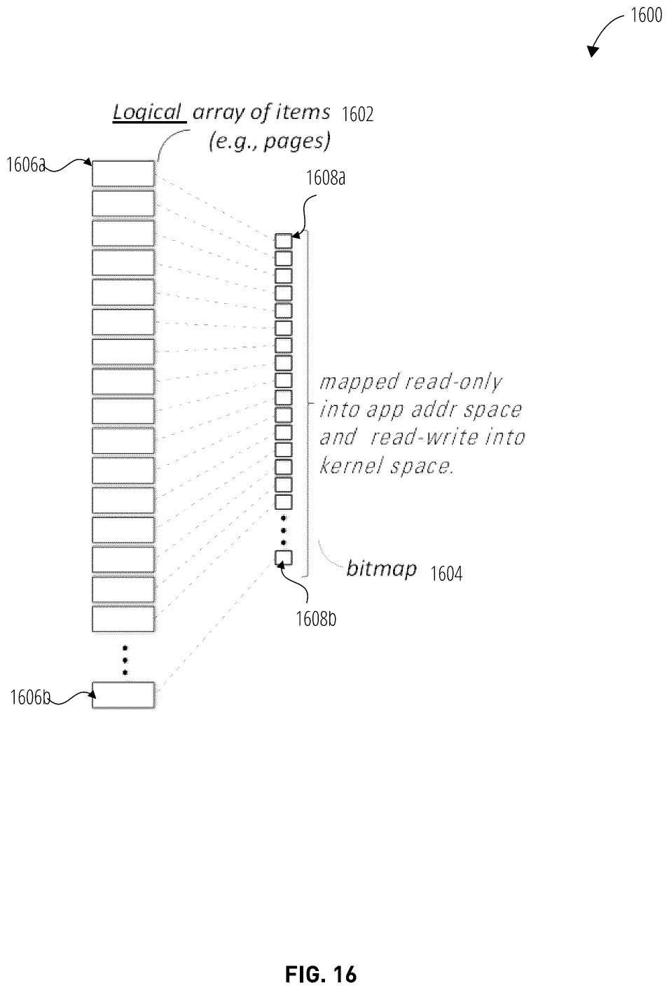

FIG. 16 is a schematic 1600 illustrating an embodiment of facilitating high bandwidth and low latency bidirectional information flow using interpreted inter-layer bitmaps. As shown, FIG. 16 depicts example bitmaps 1602 and 1604. The bitmap 1602 may include a logical representation of arrays of data items including but not limited to, virtual pages, virtual page frame numbers, etc. Therefore, for example, element 1606a and element 1606b of bitmap 1602 may correspond to respective virtual page numbers, respective virtual page frame numbers, or any other data element. As shown, respective elements of bitmap 1602 are mapped to respective elements of bitmap 1604. In some embodiments, the bitmap 1604 is mapped into both an application's address space and into a manager's address space (where a manager may be an OS kernel, a virtual machine, etc.).

Therefore, more generally, the bitmaps 1602, 1604 may provide mechanisms for applications to communicate. For example, a first application may write to bitmap 1602 to communicate information to a second application. Similarly, the second application may write to bitmap 1604 to communicate information to the first application. Therefore, the first application may read the bitmap 1604 to receive information from the second application, and the second application may read bitmap 1602 to receive information from the first application.

An application may access bitmap 1604 with read-only privileges by default, via the mapping of bitmap 1602 to bitmap 1604. Similarly, the manager has read-write access to bitmap 1604 and bitmap 1602 through the mappings of bitmap 1604. As a result, the manager can communicate a particular type of status of all items in bitmap 1602 directly through memory, e.g., one or more bits of information stored in the elements 1608a-1608b of bitmap 1604. For example, an OS kernel may signal, to the application via the bitmap 1604, which virtual pages indicated in the bitmap 1602 were accessed at least once in last K units of time.

Similarly, a bitmap in the reverse direction permits an application to convey one or more bits of intent to the manager about each logical element of such an array. Thus for example, an application may use elements 1606a-1606b of bitmap 1602 to convey, to the kernel, an intent to prioritize some number of pages for a write-back. The kernel may then prioritize cleaning IOs for those pages indicated by set bits in the bitmap 1604.

The information flow supported by bitmaps 1602, 1604 may support communication of any type of information. For example, in one direction, item-granular usage hints may be provided. In such an example, the other direction may provide item-granular monitored information about observed access rates, types of accesses, sources of access (such as whether accessed by a CPU, I/O hub, an accelerator, etc.)

As another example, in one direction via bitmaps 1602, 1604, a request for obtaining which of various indicated items were found to be part of sequential I/O accesses may be processed. In the other direction, the bitmaps 1602, 1604 may provide monitored information about sequential or non-sequential nature of observed accesses.

As another example, in one direction via bitmaps 1602, 1604 may, requests for soft-pinning various indicated items may be issued. In the reverse direction, the bitmaps 1602, 1604 may be used to return an indication for whether or not those items have been soft-pinned. Soft-pinning may result in not reclaiming an object that is soft-pinned without issuing a notification that the object will need to be reclaimed within a predetermined number units of time.

Generally, IDL describes an API contract between one layer and another. An IDL compiler may create various client and server side stubs. Applied to telemetry data 202 flowing between layers, including two example layers U (upper layer) and L (lower layer). Layer U may want to collect some information about the state of many items in layer L. Layer U may further want to export, to layer L, information about the priority it gives to the different items in layer L for various operations such as prefetching, eager reclaiming, scheduling operations, etc.

Therefore, in some embodiments, the bitmaps 1602, 1604 may be created by the IDL compiler. In some embodiments, one of the bitmaps may be writeable by layer L and readable by layer U, while the other bitmap may be writeable by layer U and readable by layer L. However, in such embodiments, layers U and L may have full read access and write access to each bitmap 1602, 1604.

More generally, the bitmaps 1602, 1604 allow different layers to perform operations on each other at low latency and with high bandwidth. Furthermore, the summary result may be collected in a bitmapped data structure S as well, so there is no concern about waiting for the operation to be over.

Additional IDL interfaces may provide functions to perform operations on the bitmaps 1602, 1604, based on the bits in the bitmaps 1602, 1604 having values of 0, 1. As such, the following code semantic may represent various embodiments:

| do_bitmapped_func_if (b, B, f, S) : | |
|---|---|
| \| | for all items j mapped by B.bitmap: |
| \| | \| if (j.value == b) : |
| \| | \| perform f (j) |
| \| | collect_a_result (S) |

With the statement “if (j.value==b): perform f(j)”, a layer is effectively asking its counterpart layer to apply a safe function (such as one that can be supplied via eBPF) to each entity identified by whether its corresponding bit-mapped value in bitmaps 1602, 1604 is 0 or 1. This may provide a compact way of performing a bulk-operations, a way that is efficient for the other layer to perform. For example, an upper layer may want to notify a lower layer that it is about to issue a number of writes to various sparsely distributed virtual pages. As such, the upper layer may attempt to minimize the number of copy-on-write (CoW) faults. The minimization of CoW faults may be met by the upper layer instructing the lower layer to scan through its own data structures and perform a bulk CoW operation if it can find sufficient number of physical page-frames, which may be what the function “f” represents in the above code semantic. As another example, “perform f(j)” in the above code semantic may be used to downgrade writeable pages to CoW and to obtain a write-heat-map over the indicated set.

The “collect_a_result(S)” portion of the semantic may include optional conditions. For example, the collect_a_result procedure may optionally wait for the last outstanding application of function f( ) to be completed. Doing so may be useful, for example, when there is a need for the calling layer to receive such a confirmation. However, in some embodiments, the “collect_a_result” by default returns a result immediately with the do_bitmapped_function_if) applied asynchronously in the called layer. In such embodiments, the calling layer may poll on S if it is interested in obtaining a summary when the operation f( ) completes. For actionable telemetry usages, telemetry data 202 whose purpose is operational can use the synchronous option, but otherwise it allows telemetry watchers 110a-110c, telemetry aggregators 104, and decision processes based on telemetry collection to act asynchronously and concurrently.

More generally, the upper layer, may not need to have the ability to perform the operation f. The operation f itself may be a procedure immutable to the upper layer (e.g., it is defined once in the upper layer and passed to the lower layer), but which the upper layer can ask the lower layer to perform (e.g., as if it is a lightweight system call that an application can ask an OS to perform). However, the upper layer may tailor the application of f by changing the parameters for each application of f. Thus, the disclosed interface acts like a wide but shallow system call over an open-ended collection of items in the lower layer. In some embodiments, the result vector S may be automatically encrypted with a key registered by the upper layer into the lower layer.

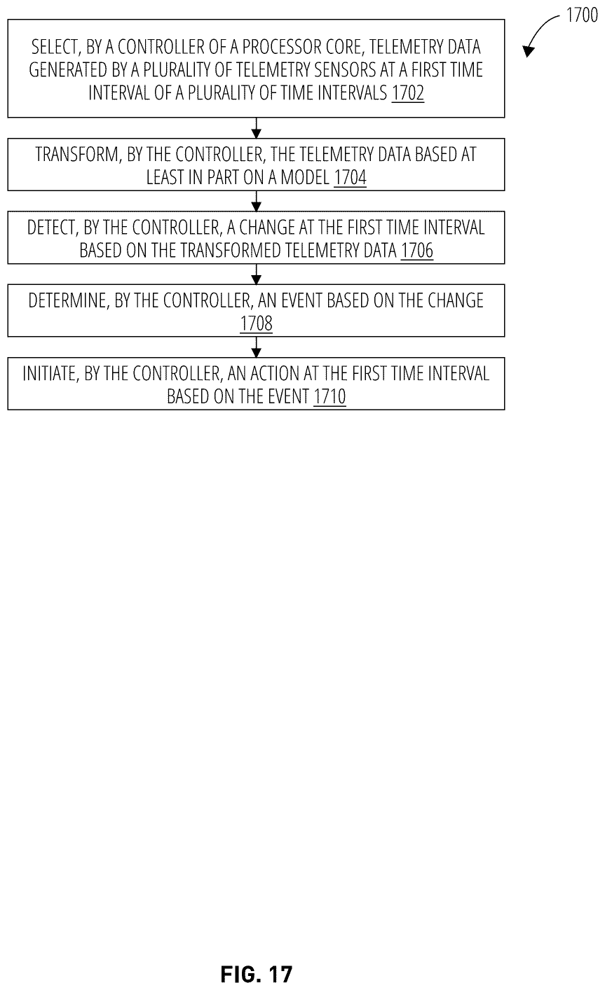

FIG. 17 illustrates an embodiment of a logic flow 1700. The logic flow 1700 may be representative of some or all of the operations executed by one or more embodiments described herein. For example, the logic flow 1700 may include some or all of the operations to provide actionable telemetry in an apparatus such as apparatus 300. Embodiments are not limited in this context.

In block 1702, logic flow 1700 selects, by a controller such as the SMA 312a of PMA 310a of a processor core such as core 308a, telemetry data 202 generated by a plurality of telemetry sensors such as telemetry sensors 114a-114g at a first time interval of a plurality of time intervals. In block 1704, logic flow 1700 transforms, by the controller, the telemetry data based at least in part on a model such as the TML 404. In block 1706, logic flow 1700 detects, by the controller, a change at the first time interval based on the transformed telemetry data. In block 1708, logic flow 1700 determines, by the controller, an event based on the change. In block 1710, logic flow 1700 initiates, by the controller, an action at the first time interval based on the event.

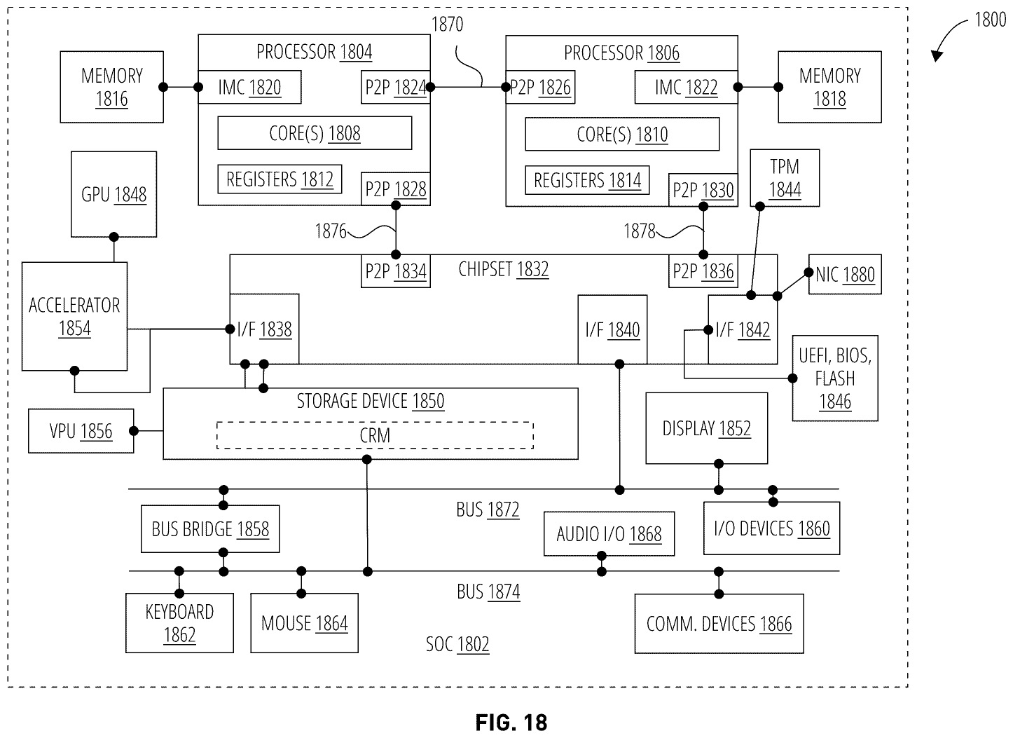

FIG. 18 illustrates an embodiment of a system 1800. System 1800 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), an Infrastructure Processing Unit (IPU), a data processing unit (DPU), or other device for processing, displaying, or transmitting information. Examples of IPUs include the AMD® Pensando IPU. Examples of DPUs include the Fungible DPU, the Marvell® OCTEON and ARMADA DPUs, the NVIDIA BlueField® DPU, the ARM® Neoverse N2 DPU, and the AMD® Pensando DPU. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 1800 may have a single processor with one core or more than one processor. Note that the term “processor” refers to a processor with a single core or a processor package with multiple processor cores. In at least one embodiment, the computing system 1800 includes the components of the apparatus 300, the telemetry architecture 102, and telemetry architecture 200. More generally, the computing system 1800 is configured to implement all logic, systems, logic flows, methods, apparatuses, software, and functionality described herein with reference to previous figures.

As used in this application, the terms “system” and “component” and “module” are intended to refer to a computer-related entity, either hardware, a combination of hardware and software, software, or software in execution, examples of which are provided by the exemplary system 1800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 18, system 1800 comprises a system-on-chip (SoC) 1802 for mounting platform components. System-on-chip (SoC) 1802 is a point-to-point (P2P) interconnect platform that includes a first processor 1804 and a second processor 1806 coupled via a point-to-point interconnect 1870 such as an Ultra Path Interconnect (UPI). In other embodiments, the system 1800 may be of another bus architecture, such as a multi-drop bus. Furthermore, each of processor 1804 and processor 1806 may be processor packages with multiple processor cores including core(s) 1808 and core(s) 1810, respectively. Core(s) 1808 and 1810 are representative of cores 308a-308c of FIG. 3, each of which includes at least one PMA such as PMA 310a-310c (and an associated SMA such as SMA 312a-312c). While the system 1800 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform may refers to a motherboard with certain components mounted such as the processor 1804 and chipset 1832. Some platforms may include additional components and some platforms may only include sockets to mount the processors and/or the chipset. Furthermore, some platforms may not have sockets (e.g. SoC, or the like). Although depicted as a SoC 1802, one or more of the components of the SoC 1802 may also be included in a single die package, a multi-chip module (MCM), a multi-die package, a chiplet, a bridge, an interposer, an. Therefore, embodiments are not limited to a SoC.

The processor 1804 and processor 1806 can be any of various commercially available processors, including without limitation AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 1804 and/or processor 1806. Additionally, the processor 1804 need not be identical to processor 1806.

Processor 1804 includes an integrated memory controller (IMC) 1820 and point-to-point (P2P) interface 1824 and P2P interface 1828. Similarly, the processor 1806 includes an IMC 1822 as well as P2P interface 1826 and P2P interface 1830. IMC 1820 and IMC 1822 couple the processor 1804 and processor 1806, respectively, to respective memories (e.g., memory 1816 and memory 1818). Memory 1816 and memory 1818 may be portions of the main memory (e.g., a dynamic random-access memory (DRAM)) for the platform such as double data rate type 4 (DDR4) or type 5 (DDR5) synchronous DRAM (SDRAM). In the present embodiment, the memory 1816 and the memory 1818 locally attach to the respective processors (e.g., processor 1804 and processor 1806). In other embodiments, the main memory may couple with the processors via a bus and shared memory hub. Processor 1804 includes registers 1812 and processor 1806 includes registers 1814.

System 1800 includes chipset 1832 coupled to processor 1804 and processor 1806. Furthermore, chipset 1832 can be coupled to storage device 1850, for example, via an interface (I/F) 1838. The I/F 1838 may be, for example, a Peripheral Component Interconnect-enhanced (PCIe) interface, a Compute Express Link® (CXL) interface, or a Universal Chiplet Interconnect Express (UCIe) interface. Storage device 1850 can store instructions executable by circuitry of system 1800 (e.g., processor 1804, processor 1806, GPU 1848, accelerator 1854, vision processing unit 1856, or the like). Furthermore, storage device 1850 can store telemetry data 202 or the like.

Processor 1804 couples to the chipset 1832 via P2P interface 1828 and P2P 1834 while processor 1806 couples to the chipset 1832 via P2P interface 1830 and P2P 1836. Direct media interface (DMI) 1876 and DMI 1878 may couple the P2P interface 1828 and the P2P 1834 and the P2P interface 1830 and P2P 1836, respectively. DMI 1876 and DMI 1878 may be a high-speed interconnect that facilitates, e.g., eight Giga Transfers per second (GT/s) such as DMI 3.0. In other embodiments, the processor 1804 and processor 1806 may interconnect via a bus.

The chipset 1832 may comprise a controller hub such as a platform controller hub (PCH). The chipset 1832 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1832 may comprise more than one controller hub such as a chipset with a memory controller hub, a graphics controller hub, and an input/output (I/O) controller hub.

In the depicted example, chipset 1832 couples with a trusted platform module (TPM) 1844 and UEFI, BIOS, FLASH circuitry 1846 via I/F 1842. The TPM 1844 is a dedicated microcontroller designed to secure hardware by integrating cryptographic keys into devices. The UEFI, BIOS, FLASH circuitry 1846 may provide pre-boot code.

Furthermore, chipset 1832 includes the I/F 1838 to couple chipset 1832 with a high-performance graphics engine, such as, graphics processing circuitry or a graphics processing unit (GPU) 1848. In other embodiments, the system 1800 may include a flexible display interface (FDI) (not shown) between the processor 1804 and/or the processor 1806 and the chipset 1832. The FDI interconnects a graphics processor core in one or more of processor 1804 and/or processor 1806 with the chipset 1832.

The system 1800 is operable to communicate with wired and wireless devices or entities via the network interface controller (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE, 5G, 6G wireless technologies, among others. Thus, the communication can be a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network can be used to connect computers to each other, to the Internet, and to wired networks (which use IEEE 802.3-related media and functions).

Additionally, accelerator 1854 and/or vision processing unit 1856 can be coupled to chipset 1832 via I/F 1838. The accelerator 1854 is representative of any type of accelerator device (e.g., a data streaming accelerator, cryptographic accelerator, cryptographic coprocessor, an offload engine, etc.). Examples of accelerators 1854 include the AMD Instinct® or Radeon® accelerators. Other examples of accelerators 1854 include the NVIDIA® HGX and SCX accelerators. Another example of an accelerator 1854 includes the ARM Ethos-U NPU. The accelerator 1854 is representative of the SIL hardware accelerators 422.

The accelerator 1854 may be a device including circuitry to accelerate copy operations, data encryption, hash value computation, data comparison operations (including comparison of data in memory 1816 and/or memory 1818), and/or data compression. For example, the accelerator 1854 may be a USB device, PCI device, PCIe device, CXL device, UCIe device, and/or an SPI device. The accelerator 1854 can also include circuitry arranged to execute machine learning (ML) related operations (e.g., training, inference, etc.) for ML models. Generally, the accelerator 1854 may be specially designed to perform computationally intensive operations, such as hash value computations, comparison operations, cryptographic operations, and/or compression operations, in a manner that is more efficient than when performed by the processor 1804 or processor 1806. Because the load of the system 1800 may include hash value computations, comparison operations, cryptographic operations, and/or compression operations, the accelerator 1854 can greatly increase performance of the system 1800 for these operations.

The accelerator 1854 may be embodied as any type of device, such as a coprocessor, application-specific integrated circuit (ASIC), field-programmable gate array (FPGA), functional block, IP core, graphics processing unit (GPU), a processor with specific instruction sets for accelerating one or more operations, or other hardware accelerator of the computing device 202 capable of performing the functions described herein. In some embodiments, the accelerator 1854 may be packaged in a discrete package, an add-in card, a chipset, a multi-chip module (e.g., a chiplet, a dielet, etc.), and/or an SoC. Embodiments are not limited in these contexts.

The accelerator 1854 may include one or more dedicated work queues and one or more shared work queues (each not pictured). Generally, a shared work queue is configured to store descriptors submitted by multiple software entities. The software may be any type of executable code, such as a process, a thread, an application, a virtual machine, a container, a microservice, etc., that share the accelerator 1854. For example, the accelerator 1854 may be shared according to the Single Root I/O virtualization (SR-IOV) architecture and/or the Scalable I/O virtualization (S-IOV) architecture. As another example, an instruction may use a Process Address Space ID (PASID). A PASID may be assigned to each of a plurality of processes executing on the host hardware. Doing so enables sharing of the device accelerator 1854 across multiple processes while providing each process a complete virtual address space. Embodiments are not limited in these contexts. In some embodiments, software uses an instruction to atomically submit the descriptor to the accelerator 1854 via a non-posted write (e.g., a deferred memory write (DMWr)). One example of an instruction that atomically submits a work descriptor to the shared work queue of the accelerator 1854 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1854. The dedicated work queue may accept job submissions via commands such as the movdir64b instruction.

Various I/O devices 1860 and display 1852 couple to the bus 1872, along with a bus bridge 1858 which couples the bus 1872 to a second bus 1874 and an I/F 1840 that connects the bus 1872 with the chipset 1832. In one embodiment, the second bus 1874 may be a low pin count (LPC) bus. Various devices may couple to the second bus 1874 including, for example, a keyboard 1862, a mouse 1864 and communication devices 1866.

Furthermore, an audio I/O 1868 may couple to second bus 1874. Many of the I/O devices 1860 and communication devices 1866 may reside on the system-on-chip (SoC) 1802 while the keyboard 1862 and the mouse 1864 may be add-on peripherals. In other embodiments, some or all the I/O devices 1860 and communication devices 1866 are add-on peripherals and do not reside on the system-on-chip (SoC) 1802.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-18 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

Example 1 includes an apparatus, comprising: a plurality of sensors; a processor core, the processor to comprise a controller coupled to the sensors, the controller operable to execute instructions to cause the controller to: select telemetry data generated by the plurality of sensors at a first time interval of a plurality of time intervals; transform the telemetry data based at least in part on a model; detect a change at the first time interval based on the transformed telemetry data; determine an event based on the change; and initiate an action during the first time interval based on the event.

Example 2 includes the subject matter of example 1, wherein the initiation of the action is to comprise instructions to cause the controller to: modify a configuration of the controller from a first configuration to a second configuration.

Example 3 includes the subject matter of example 1, wherein the model is to transform the telemetry data based at least in part on generating one or more histograms based on the telemetry data.

Example 4 includes the subject matter of example 1, the controller operable to execute instructions to cause the controller to: instruct a hardware accelerator of the controller to compute a statistic based on the telemetry data.

Example 5 includes the subject matter of example 4, the controller operable to execute instructions to cause the controller to: instruct a decision forest of the hardware accelerator to determine the event based at least in part on the statistic, the selected telemetry data, the transformed telemetry data, and the change.

Example 6 includes the subject matter of example 1, the controller operable to execute instructions to cause the controller to: instruct a hardware accelerator of the controller to insert one or more markers in the telemetry data.

Example 7 includes the subject matter of example 1, the controller operable to execute instructions to cause the controller to: send the telemetry data to an aggregator executing on a controller of a memory hub of the apparatus.

Example 8 includes a non-transitory computer-readable storage medium, the computer-readable storage medium including instructions that when executed by a controller of a processor core, cause the controller to: select telemetry data generated by a plurality of sensors of the processor core at a first time interval of a plurality of time intervals; transform the telemetry data based at least in part on a model; detect a change at the first time interval based on the transformed telemetry data; determine an event based on the change; and initiate an action during the first time interval based on the event.

Example 9 includes the subject matter of example 8, wherein the initiation of the action is to comprise instructions to cause the controller to: modify a configuration of the controller from a first configuration to a second configuration.

Example 10 includes the subject matter of example 8, wherein the model is to transform the telemetry data based at least in part on generating one or more histograms based on the telemetry data.

Example 11 includes the subject matter of example 8, wherein the instructions further cause the controller to: instruct a hardware accelerator of the controller to compute a statistic based on the telemetry data.

Example 12 includes the subject matter of example 11, wherein the instructions further cause the controller to: instruct a decision forest of the hardware accelerator to determine the event based at least in part on the statistic, the selected telemetry data, the transformed telemetry data, and the change.

Example 13 includes the subject matter of example 8, wherein the instructions further cause the controller to: instruct a hardware accelerator of the controller to insert one or more markers in the telemetry data.

Example 14 includes the subject matter of example 8, wherein the instructions further cause the controller to: send the telemetry data to an aggregator executing on a controller of a memory hub.

Example 15 includes a method, comprising: selecting, by a controller of a processor core, telemetry data generated by a plurality of sensors at a first time interval of a plurality of time intervals; transforming, by the controller, the telemetry data based at least in part on a model; detecting, by the controller, a change at the first time interval based on the transformed telemetry data; determining, by the controller, an event based on the change; and initiating, by the controller, an action at during first time interval based on the event.

Example 16 includes the subject matter of example 15, wherein initiating the action comprises: modifying, by the controller, a configuration of the controller from a first configuration to a second configuration.

Example 17 includes the subject matter of example 15, wherein the model is to transform the telemetry data based at least in part on generating one or more histograms based on the telemetry data.

Example 18 includes the subject matter of example 15, further comprising: instructing, by the controller, a hardware accelerator of the controller to compute a statistic based on the telemetry data.

Example 19 includes the subject matter of example 18, further comprising: instructing, by the controller, a decision forest of the hardware accelerator to determine the event based at least in part on the statistic, the selected telemetry data, the transformed telemetry data, and the change.

Example 20 includes the subject matter of example 15, further comprising: instructing, by the controller, a hardware accelerator of the controller to insert one or more markers in the telemetry data.

Example 21 includes the subject matter of example 15, further comprising: sending, by the controller, the telemetry data to an aggregator executing on a controller of a memory hub.

Example 22 includes a computing apparatus comprising: means for selecting telemetry data generated by a plurality of sensors at a first time interval of a plurality of time intervals; means for transforming the telemetry data based at least in part on a model; means for detecting a change at the first time interval based on the transformed telemetry data; means for determining an event based on the change; and means for initiating an action at during first time interval based on the event.

Example 23 includes the subject matter of example 22, wherein initiating the action comprises: means for modifying a configuration of the apparatus from a first configuration to a second configuration.

Example 24 includes the subject matter of example 22, wherein the model is to transform the telemetry data based at least in part on generating one or more histograms based on the telemetry data.

Example 25 includes the subject matter of example 22, further comprising: means for instructing a hardware accelerator of the controller to compute a statistic based on the telemetry data.

Example 26 includes the subject matter of example 25, further comprising: means for instructing a decision forest of the hardware accelerator to determine the event based at least in part on the statistic, the selected telemetry data, the transformed telemetry data, and the change.

Example 27 includes the subject matter of example 22, further comprising: means for instructing a hardware accelerator of the controller to insert one or more markers in the telemetry data.

Example 28 includes the subject matter of example 22, further comprising: means for sending the telemetry data to an aggregator executing on a controller of a memory hub of the apparatus.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. An apparatus, comprising:
a plurality of sensors;
a processor core, the processor to comprise a controller coupled to the sensors, the controller operable to execute instructions to cause the controller to:
select telemetry data generated by the plurality of sensors at a first time interval of a plurality of time intervals;
transform the telemetry data based at least in part on a model;
detect a change at the first time interval based on the transformed telemetry data;
determine an event based on the change; and
initiate an action during the first time interval based on the event.

2. The apparatus of claim 1, wherein the initiation of the action is to comprise instructions to cause the controller to:
modify a configuration of the controller from a first configuration to a second configuration.

3. The apparatus of claim 1, wherein the model is to transform the telemetry data based at least in part on generating one or more histograms based on the telemetry data.

4. The apparatus of claim 1, the controller operable to execute instructions to cause the controller to:
instruct a hardware accelerator of the controller to compute a statistic based on the telemetry data.

5. The apparatus of claim 4, the controller operable to execute instructions to cause the controller to:
instruct a decision forest of the hardware accelerator to determine the event based at least in part on the statistic, the selected telemetry data, the transformed telemetry data, and the change.

6. The apparatus of claim 1, the controller operable to execute instructions to cause the controller to:
instruct a hardware accelerator of the controller to insert one or more markers in the telemetry data.

7. The apparatus of claim 1, the controller operable to execute instructions to cause the controller to:
send the telemetry data to an aggregator executing on a controller of a memory hub of the apparatus.

8. A non-transitory computer-readable storage medium, the computer-readable storage medium including instructions that when executed by a controller of a processor core, cause the controller to:
select telemetry data generated by a plurality of sensors of the processor core at a first time interval of a plurality of time intervals;
transform the telemetry data based at least in part on a model;
detect a change at the first time interval based on the transformed telemetry data;
determine an event based on the change; and
initiate an action during the first time interval based on the event.

9. The computer-readable storage medium of claim 8, wherein the initiation of the action is to comprise instructions to cause the controller to:
modify a configuration of the controller from a first configuration to a second configuration.

10. The computer-readable storage medium of claim 8, wherein the model is to transform the telemetry data based at least in part on generating one or more histograms based on the telemetry data.

11. The computer-readable storage medium of claim 8, wherein the instructions further cause the controller to:
instruct a hardware accelerator of the controller to compute a statistic based on the telemetry data.

12. The computer-readable storage medium of claim 11, wherein the instructions further cause the controller to:
instruct a decision forest of the hardware accelerator to determine the event based at least in part on the statistic, the selected telemetry data, the transformed telemetry data, and the change.

13. The computer-readable storage medium of claim 8, wherein the instructions further cause the controller to:
instruct a hardware accelerator of the controller to insert one or more markers in the telemetry data.

14. The computer-readable storage medium of claim 8, wherein the instructions further cause the controller to:
send the telemetry data to an aggregator executing on a controller of a memory hub.

15. A method, comprising:
selecting, by a controller of a processor core, telemetry data generated by a plurality of sensors at a first time interval of a plurality of time intervals;
transforming, by the controller, the telemetry data based at least in part on a model;
detecting, by the controller, a change at the first time interval based on the transformed telemetry data;
determining, by the controller, an event based on the change; and
initiating, by the controller, an action at during first time interval based on the event.

16. The method of claim 15, wherein initiating the action comprises:
modifying, by the controller, a configuration of the controller from a first configuration to a second configuration.

17. The method of claim 15, wherein the model is to transform the telemetry data based at least in part on generating one or more histograms based on the telemetry data.

18. The method of claim 15, further comprising:
instructing, by the controller, a hardware accelerator of the controller to compute a statistic based on the telemetry data.

19. The method of claim 18, further comprising:
instructing, by the controller, a decision forest of the hardware accelerator to determine the event based at least in part on the statistic, the selected telemetry data, the transformed telemetry data, and the change.

20. The method of claim 15, further comprising:
instructing, by the controller, a hardware accelerator of the controller to insert one or more markers in the telemetry data.
